(19) United States
(12) Patent Application Publication
(10) Pub. No.: US 2023/0263168 A1
(43) Pub. Date: Aug. 24, 2023

(54) COMBINED FUNGICIDAL PREPARATIONS AND METHODS FOR USING THEREOF

(71) Applicant: SAVE FOODS LTD., Tel Aviv (IL)

(72) Inventors: Neta MATIS, Hod Hasharon (IL); Dan SZTYBEL, Raanana (IL); Nimrod BEN YEHUDA, Kiryat Tivon (IL)

(73) Assignee: SAVE FOODS LTD., Tel Aviv (IL)

(21) Appl. No.: 18/012,486

(22) PCT Filed: Jun. 23, 2021
(86) PCT No.: PCT/IL2021/050770

§ 371 Date: Dec. 22, 2022

Related U.S. Application Data
(60) Provisional application No. 63/126,649, filed on Dec. 17, 2020.
(60) Provisional application No. 63/042,622, filed on Jun. 23, 2020.

(51) Int. Cl. A01N 59/26; A01N 37/04; A01N 37/36; A01P 3/00

(52) U.S. Cl. CPC A01N 59/26; A01N 37/04; A01N 37/36; A01P 3/00

(57) ABSTRACT

The present invention is related to compositions, kits and articles such as for reducing pathogen load on a substrate.

### CROSS-REFERENCE TO RELATED APPLICATIONS

This application is a PCT International Application claiming the benefit of priority of U.S. Patent Application No. 63/042,622, filed Jun. 23, 2020, and of U.S. Patent Application No. 63/126,649, filed Dec. 17, 2020, which are hereby incorporated by reference in their entirety.

### FIELD OF THE INVENTION

The invention relates generally to the field of compositions and methods for using thereof such as for reducing pathogen load on a substrate or for prolonging shelf-life of an edible matter.

### BACKGROUND

Green mold, caused by Penicillium digitatum, is probably the most common worldwide postharvest disease of citrus fruits. During postharvest handling, about 90% of production loss is caused due to this disease. Synthetic postharvest fungicides such as imazalil (IMZ) and thiabendazole are widely used to control green mold. With the appearance of strains resistant to fungicides, increased doses have been necessary to effectively protect fruits. However, residues of these compounds in fruit may exceed the maximum residue limit allowed by importing countries. Since the commercial fungicides are toxic, there is an unmet need to provide improved anti-microbial compositions having lower effective amount of fungicide, so to reduce fungicide residuals in fruits and vegetables.

Additionally, postharvest fungicides can be added at various points before or during the packaging process. Usually, the fungicides together with coating are applied by dipping or by spraying. Combined application of the coating together with the fungicide might be advantageous with respect to green mold control and sporulation inhibition, compared to either treatment alone. This is partly due to the fact that the different application methods provide different types of control. Dip application provides good curative control while the coating provides increased protective control against pathogens.

Thus, alternative compositions for improving shelf-life and quality of the fruits during prolonged storage, and for reducing pathogen related fruit diseases are required.

The foregoing examples of the related art and limitations related therewith are intended to be illustrative and not exclusive. Other limitations of the related art will become apparent to those of skill in the art upon a reading of the specification and a study of the figures.

### SUMMARY

In one aspect, there is provided a composition comprising (i) an acid component, a salt thereof or both, and (ii) an additional component selected from a fungicide and a hydrophobic coating, or both; wherein said acid component comprises an inorganic acid; a C1-C10 carboxylic acid or both.

In some embodiments, a weight per weight (w/w) ratio of said acid component to said fungicide within the composition is between 15:1 and 1:2.

In some embodiments, a w/w concentration of said fungicide within the composition is at least 50 ppm.

In some embodiments, a w/w concentration of said acid component within said composition is at least 50 ppm.

In some embodiments, said C1-C10 carboxylic acid is selected from the group consisting of propionic acid, tartaric acid, glycolic acid, butanoic acid, pyruvic acid, citric acid, malic acid, mandelic acid, and lactic acid, including any salt and any combination thereof.

In some embodiments, said acid component comprises propionic acid and an additional C1-C10 carboxylic acid.

In some embodiments, said inorganic acid is selected from the group consisting of phosphorous acid, phosphoric acid, hydrochloric acid, sulfuric acid, nitric acid, including any salt and any combination thereof.

In some embodiments, said fungicide comprises an azole-based fungicide.

In some embodiments, a pH of said composition is between 0 and 7.

In some embodiments, said composition further comprises an agent selected from the group consisting of: a carrier gas, a solvent, a surfactant, an additive, and a stabilizer or any combination thereof.

In some embodiments, the w/w concentration of said agent within said composition is in a range from 0.1 to 20%.

In some embodiments, said composition is stable for at least 48h.

According to another aspect, there is provided a kit comprising (i) a first compartment comprising an inorganic acid, a C1-C10 carboxylic acid or both; and (ii) a second compartment comprising a fungicide, a hydrophobic coating or both.

In some embodiments, the inorganic acid is selected from the group consisting of phosphorous acid, phosphoric acid, hydrochloric acid, sulfuric acid, nitric acid, including any salt and any combination thereof.

In some embodiments, said C1-C10 carboxylic acid is selected from the group consisting of propionic acid, tartaric acid, glycolic acid, butanoic acid, pyruvic acid, citric acid, malic acid, mandelic acid, and lactic acid, including any salt and any combination thereof.

In some embodiments, said fungicide comprises an azole-based fungicide.

In some embodiments, said hydrophobic coating comprises a water insoluble compound selected from the group comprising a lipid, a fatty acid, a water insoluble polysaccharide, and a water insoluble protein or any combination thereof.

In some embodiments, any one of said first compartment, and said second compartment, comprises an agent selected from the group consisting of: a surfactant, an additive, a solvent, and a stabilizer or any combination thereof.

In some embodiments, any one of said first compartment, said second compartment, and said third compartment is stable for at least 12 months.

According to some embodiments, there is provided a method for enhancing or prolonging activity of a fungicide, comprising:

i. providing a substrate; and

ii. contacting said substrate with an effective amount of the composition or the kit of the present invention, thereby enhancing or prolonging activity of said fungicide.

In some embodiments, said effective amount comprises a concentration of said fungicide within said composition or within said kit being between 50 and 10,000 ppm.

In some embodiments, said method is for at least one of (i) preventing or controlling pathogen related decay of an edible matter, (ii) inducing or enhancing susceptibility of a pathogen to said fungicide.

According to some embodiments, there is provided a method for reducing a dose of a fungicide applied to a substrate, comprising:

i. providing a substrate;

ii. contacting said substrate with an effective dose of the composition or of the kit of the present invention, wherein an amount of said fungicide within said effective dose is less than a recommended dose for said fungicide.

In some embodiments, said contacting is selected from the group consisting of: spraying, fogging, submerging, dipping, and injecting or any combination thereof.

In some embodiments, said substrate is selected for the group consisting of: an edible matter, a growth medium, a propagation medium, a harvesting surface, a container, a storage surface, a transport surface, a packaging surface, a treatment surface, and a processing surface or any combination thereof.

In some embodiments, said fungicide comprises an azole-based fungicide.

In some embodiments, said pathogen is selected from the group consisting of bacteria, yeast and fungi or any combination thereof.

According to another aspect, there is provided an article comprising a substrate in contact with a coating comprising propionic acid and a plurality of C1-C10 carboxylic acids.

In some embodiments, said C1-C10 carboxylic acid is selected from the group consisting of propionic acid, tartaric acid, glycolic acid, butanoic acid, pyruvic acid, citric acid, malic acid, mandelic acid, and lactic acid, including any salt and any combination thereof.

In some embodiments, said plurality of C1-C10 carboxylic acids comprises citric acid and lactic acid.

In some embodiments, said substrate is selected for the group consisting of: an edible matter, a growth medium, a propagation medium, a harvesting surface, a container, a storage surface, a transport surface, a packaging surface, a treatment surface, and a processing surface or any combination thereof.

In some embodiments, said coating further comprises a hydrophobic coating, a fungicide or both.

In some embodiments, said hydrophobic coating comprises a water insoluble compound selected from the group comprising a lipid, a fatty acid, a water insoluble polysaccharide, and a water insoluble protein or any combination thereof.

In some embodiments, said fungicide comprises an azole-based fungicide.

In some embodiments, said article is characterized by any of (i) reduced pathogen load, (ii) prolonged storage shelf-life or both (i) and (ii).

In another aspect, there is provided an antimicrobial composition comprising an effective amount of an acid component, and a fungicidally effective amount of a fungicide; wherein said acid component comprises (i) an inorganic acid, a salt thereof or both; (ii) a C1-C10 carboxylic acid a salt thereof or both, or a combination of (i) and (ii); and wherein the effective amount of the acid component is so that the fungicidally effective amount of the fungicide is reduced by at least 10%, compared to a similar antimicrobial composition without the acid component.

In some embodiments, the effective amount of the acid component comprises a weight per weight (w/w) ratio of said acid component to said fungicide within the antimicrobial composition of between 15:1 and 1:2.

In some embodiments, the fungicidally effective amount is at least 30 ppm.

In some embodiments, the effective amount of the acid component within said antimicrobial composition is at least 50 ppm.

In some embodiments, the antimicrobial composition further comprises an antimicrobial effective amount of an oxidizing agent,

In some embodiments, the antimicrobial effective amount of the oxidizing agent is at least 10 ppm.

In another aspect, there is provided a method for reducing a dose of a fungicide applied to a substrate, comprising contacting said substrate with an effective dose of (i) the antimicrobial composition of the invention, or of (ii) the kit of the invention, wherein the fungicidal effective amount of said fungicide within said antimicrobial composition or within said kit is reduced by at least 10%, compared to a similar antimicrobial composition or kit without the acid component.

In some embodiments, the substrate comprises edible matter, and wherein the method is performed on post-harvest or pre-harvest edible matter.

In another aspect, there is provided a method comprising contacting a substrate with an effective amount of (i) the antimicrobial composition of the invention, or (ii) the kit of the invention; thereby enhancing or prolonging activity of said fungicide, or controlling pathogen related decay of an edible matter.

In some embodiments, the effective amount comprises a concentration of the fungicide within the antimicrobial composition or within the kit being between 50 and 10,000 ppm, or between 30 and 600 ppm; a concentration of the one or more acid component(s) within the antimicrobial composition or within the kit being between 200 and 7500 ppm, and optionally a concentration of the oxidizing agent of between 10 and 1500 ppm.

The following embodiments and aspects thereof are described and illustrated in conjunction with compositions systems, tools and methods which are meant to be exemplary and illustrative, not limiting in scope.

In addition to the exemplary aspects and embodiments described above, further aspects and embodiments will become apparent by study of the following detailed description.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a bar graph representing a percentage of edible matter decay upon treatment with numerous fungicidal compositions compared to a control (hot water). “Acids” refer to a mixture of propionic acid, citric acid, and lactic acid, at almost equal weight ratios, ±10%. “PAA” is peracetic acid.

### DETAILED DESCRIPTION

The present invention, in some embodiments thereof, is directed to a composition or to a kit comprising a synergistically effective amount (i) of an acid component, a salt and/or an ester or a tautomer thereof or both, and (ii) of a fungicide and/or a salt thereof; wherein the acid component comprises an inorganic acid; a C1-C10 carboxylic acid or both.

The invention is further directed to a method for enhancing or prolonging activity of a fungicide, comprising providing a substrate; and contacting the substrate with an effective amount of the composition or the kit of the invention under suitable conditions. In some embodiments, the effective amount is a fungicidal effective amount.

In some embodiments, the method is for preventing or controlling pathogen related decay of an edible matter.

The invention is further directed to a method for reducing a dose of a fungicide applied to a substrate.

The present invention is based, in part, on a surprising finding that a combination of an acid component comprising (i) propionic acid, lactic acid and citric acid as, or (ii) an inorganic acid such as phosphonic acid; and an azole-based fungicide, such as imazalil, exhibited a synergistic anti-pathogenic effect, upon application thereof to an edible matter. The inventors surprisingly found, that upon combined application (pre-, and/or post-harvest) of the above-mentioned acid component and the azole-based fungicide the decay of an edible matter has been significantly reduced, compared to application of a control solution containing an equal concentration of imazalil. Additionally, the above-mentioned combination, when applied to an edible matter, substantially prolonged the fungicidal effect of an azole-based fungicide (e.g. imazalil). Moreover, based on these findings, the inventors successfully reduced the effective dosage of an azole-based fungicide (e.g. imazalil) within a fungicidal composition. To this end, exemplary fungicidal compositions or combinations (kits) of the invention in some embodiments thereof, exhibited a significant synergistic anti-pathogenic effect when applied to an edible matter. Accordingly, the inventors were able to reduce the effective amount of the fungicide (e.g. imazalil) applied to edible matter.

Furthermore, citrus fruits treated with the combination of propionic acid, lactic acid and citric acid and coated with an edible coating (e.g. a plant-wax coating), surprisingly, exhibited a prolonged shelf life, and were characterized by reduced spoilage, reduced dehydration or weight loss, by reduced spotting and by reduced mechanical defects compared to citrus fruits treated solely with the plant edible coting.

Composition

In one aspect of the invention provided herein there is a composition comprising (i) an acid component, a salt thereof or both, and (ii) a fungicide; wherein the acid component comprises an inorganic acid; a C1-C10 carboxylic acid or both.

In some embodiments, the composition comprises (i) propionic acid, (ii) a fungicide, and optionally (ii) at least one of an inorganic acid, and a C1-C10 carboxylic acid. In some embodiments, the composition comprises (i) propionic acid, (ii) a fungicide, and optionally (iii) at least one of citric acid and lactic acid.

In some embodiments, the composition of the invention comprises (i) propionic acid, and optionally (ii) at least one of an inorganic acid and a C1-C10 carboxylic acid, wherein a weight per weight (w/w) concentration of any one of the acids within the composition is at least 50 ppm. In some embodiments, the composition of the invention is an antimicrobial composition.

In some embodiments, the antimicrobial composition of the invention comprises an effective amount of an acid component, and a fungicidally effective amount of a fungicide; wherein the acid component comprises (i) at least one inorganic acid, a salt thereof or both; (ii) at least one C1-C10 carboxylic acid a salt thereof or both, or a combination of (i) and (ii); and wherein the effective amount of the acid component is so that the fungicidally effective amount of the fungicide is reduced by at least 10%, at least 20%, at least 30%, at least 50%, at least 100%, at least 200%, at least 300%, at least 500%, at least 1000% compared to a control, including any range between.

In some embodiments, the fungicidally effective amount is sufficient for reduction of fungal load on or within a substrate, by at least 10%, at least 20%, at least 30%, at least 50%, at least 100%, at least 200%, at least 300%, at least 500%, at least 1000%, at least 10.000%, at least 100.000%, at least 1.000.000%, at least 10.000.000%, at least 100.000.000% (or at least by a factor ranging from 10² to 10⁷), including any range between, wherein the substrate is as described herein (e.g. post-harvest and/or pre-harvest edible matter).

In some embodiments, the fungicidally effective amount is sufficient for reduction of CFU of a pathogen (fungus) on or within the substrate (e.g. post-harvest and/or pre-harvest edible matter) by a factor of between 10 to 10,000,000 including any range between, as compared to a non-treated substrate, wherein the pathogen is a plant pathogen as described herein.

In some embodiments, the antimicrobial composition of the invention comprises a synergistically effective amount of (I) the acid component of the invention, and of (II) the fungicide; and wherein the synergistically effective amount is sufficient for reduction of plant pathogen load on or within a substrate, compared to a control. In some embodiments, reduction of plant pathogen load is by a factor of between 10 to 10,000,000 including any range between.

In some embodiments, the synergistically effective amount comprises a weight per weight (w/w) ratio of the acid component of the invention to the fungicide of the invention being between 15:1 and 1:2, 15:1 and 10:1, 10:1 and 5:1, 5:1 and 3:1, 3:1 and 2:1, 2:1 and 1:1, 1:1 and 1:2, including any range between. In some embodiments, the synergistically effective amount comprises a w/w concentration of the acid component of the invention of at least 50 ppm, at least 100 ppm, at least 200 ppm, at least 250 ppm, at least 300 ppm, at least 500 ppm, at least 1000 ppm, at least 3000 ppm, at least 5000 ppm, at least 7000 ppm, including any range between.

In some embodiments, the synergistically effective amount comprises a w/w concentration of the acid component of the invention of between 100 and 8000 ppm, between 100 and 200 ppm, between 200 and 300 ppm, between 300 and 500 ppm, between 500 and 1000 ppm, between 1000 and 3000 ppm, between 3000 and 8000 ppm, including any range between; and a w/w concentration of the fungicide of the invention of between 30 and 50 ppm, between 50 and 600 ppm, between 30 and 600 ppm, between 50 and 100 ppm, between 100 and 200 ppm, between 200 and 300 ppm, between 300 and 400 ppm, between 400 and 600 ppm, including any range between.

In some embodiments, the concentration of the active agent as used herein (e.g. fungicide, acid component and/or oxidizing agent) refer to a minimum concentration required for a synergistic antimicrobial effect, as described herein.

In some embodiments, the fungicidally effective amount of the fungicide is at least 30 ppm, at least 50 ppm, at least 100 ppm, at least 200 ppm, at least 250 ppm, at least 300 ppm, at least 500 ppm including any range between.

In some embodiments, the fungicidally effective amount of the fungicide is between 30 and 50 ppm, between 50 and 600 ppm, between 30 and 600 ppm, between 50 and 100 ppm, between 100 and 200 ppm, between 200 and 300 ppm, between 300 and 400 ppm, between 400 and 600 ppm, including any range between.

In some embodiments, the effective amount comprises a w/w concentration of the acid component of the invention of at least 50 ppm, at least 100 ppm, at least 200 ppm, at least 250 ppm, at least 300 ppm, at least 500 ppm, at least 1000 ppm, at least 3000 ppm, at least 5000 ppm, at least 7000 ppm, or between 100 and 8000 ppm, between 100 and 200 ppm, between 200 and 300 ppm, between 300 and 500 ppm, between 500 and 1000 ppm, between 1000 and 3000 ppm, between 3000 and 8000 ppm, including any range between. In some embodiments, the antimicrobial composition of the invention further comprises an effective amount of an oxidizing agent, wherein the effective amount is sufficient for reducing bacterial load as described herein, on or within the substrate. In some embodiments, the effective amount of an oxidizing agent is an antimicrobial effective amount. In some embodiments, the antimicrobial effective amount of the oxidizing agent is at least 10 ppm, as described herein.

In some embodiments, the antimicrobial composition of the invention comprising a synergistically effective amount of the acid component and of the fungicide of the invention, and further comprising an antimicrobial effective amount of the oxidizing agent is capable of reducing microbial load on or within a substrate, upon application of the antimicrobial composition on the substrate; wherein the microbe is a plant pathogen selected from plant virus, a plant fungus and/or mold, a plant bacterium, or any combination thereof.

One skilled in the art will appreciate that the exact concentration may vary depending on the application time (e.g. pre-harvest, post-harvest or at any stage of the life cycle of a fruit and/or vegetable) on the substrate and the initial pathogen load. Furthermore, the exact concentration may vary depending on the specific fungicide. One skilled in the art will further appreciate, that the exact amount and/or concentration of any of the active ingredients of the antimicrobial composition of the invention can be determined by performing well-known microbiological tests, some of which are described in the Example section.

In some embodiments, the control is an untreated substrate. In some embodiments, the control is a similar composition comprising substantially the same amount of the same fungicide as the composition of the invention; and wherein the control composition is substantially devoid of the acid component of the invention.

In some embodiments, the terms “composition”, “antimicrobial composition” are used herein interchangeably. In some embodiments, the composition of the invention further comprises an acceptable carrier or diluent. In some embodiments, the acceptable carrier is selected form an agriculturally acceptable carrier, a food acceptable carrier, or pharmaceutically acceptable carrier or diluent. In some embodiments, the acceptable carrier comprises water, an aqueous solution, an aqueous buffer, etc. In some embodiments, the acceptable carrier further comprises a surfactant.

In some embodiments, a w/w concentration of the acceptable carrier within the composition of the invention ranges between 10 and 99.99%, including any range between. In some embodiments, the acceptable carrier is present within the composition of the invention in an amount sufficient for substantially (e.g. at least 90%, at least 99%, at least 99.9% by weight) dissolving the active ingredients of the composition. In some embodiments, the acceptable carrier is present within the composition of the invention in an amount sufficient for obtaining an effective amount (e.g. antimicrobial, fungicidally, and/or synergistically effective amount) of any one of the active ingredient of the invention.

In some embodiments, the composition of the invention comprises (i) propionic acid, and optionally (ii) at least one of an inorganic acid and a C1-C10 carboxylic acid, and wherein the composition is substantially devoid of an oxidizing agent (such as hydrogen peroxide and/or a peracid), and is substantially devoid of a fungicide. In some embodiments, the composition of the invention consists essentially of (i) propionic acid, (ii) and at least one of citric acid and lactic acid, wherein the concentration of any one of the acids within the composition is at least 50 ppm.

In some embodiments, the composition comprises propionic acid, citric acid and lactic acid; and a fungicide (e.g. an azole based or a triazole based fungicide). In some embodiments, the composition comprises propionic acid, citric acid and lactic acid, a salt thereof or both. In some embodiments, the composition comprises an inorganic acid; and a fungicide. In some embodiments, the composition comprises an inorganic acid and a C1-C10 carboxylic acid; and a fungicide.

In some embodiments, the composition comprises a solvent. In some embodiments, the solvent is sufficient for substantially dissolving the components of the composition. In some embodiments, the solvent is sufficient for dissolving the fungicide and the acid component. In some embodiments, the amount of the solvent is sufficient for forming a solution or a dispersion of the acid component and the fungicide.

In some embodiments, the composition of the invention is a liquid composition. In some embodiments, the composition of the invention is a coating composition. In some embodiments, the composition of the invention is an anti-microbial composition.

In some embodiments, the composition of the invention is a fungicidal composition. In some embodiments, the composition of the invention is an antimicrobial composition.

In some embodiments, the solvent is an organic solvent. In some embodiments, the solvent is a polar organic solvent. In some embodiments, the solvent comprises a mixture of an organic solvent and an aqueous solvent.

In some embodiments, the solvent is an aqueous solvent. In some embodiments, the aqueous solvent comprises water and optionally a salt (e.g. a buffering agent).

Non-limiting examples of polar organic solvents contain but are not limited to ethanol, methanol, acetone, methyl-ethyl ketone, isopropanol, dimethyl sulfoxide, dimethylformamide, or any combination thereof.

In some embodiments, the composition is a liquid composition. In some embodiments, the composition is a liquid at a temperature between 0 and 95° C. In some embodiments, the composition is an aqueous composition, comprising: 1) the acid component; 2) the fungicide, and 3) an aqueous solvent. In some embodiments, the composition is an aqueous composition, comprising: 1) the fungicide; 2) the acid component, 3) an aqueous solvent and 4) a surfactant. In some embodiments, the composition is an aqueous composition, comprising: 1) the acid component selected from (i) propionic acid, citric acid and lactic acid; and (ii) an inorganic acid (e.g. phosphorous acid) or a combination of (i) and (ii); 2) the fungicide, 3) an aqueous solvent and optionally 4) a surfactant and/or a stabilizer.

In some embodiments, the composition is an aqueous composition having at least 10%, 20%, 30%, 40%, 50%, 60%, 70%, 80%, 90%, 95%, 98%, 99%, 99.9%, 99.999% water by weight including any range or value therebetween.

In some embodiments, the derivative, as used herein is referred to a structural isomer and/or to a chemical derivative of any of the herein disclosed acids. In some embodiments, the derivative is a biologically active derivative having an anti-microbial or anti-pathogenic activity.

In some embodiments, the acid component is substantially devoid of a peracid. In some embodiments, the composition of the invention is substantially devoid of a peracid, and/or of an oxidizing agent (such as hydrogen peroxide or a peroxide source).

In some embodiments, the acid component comprises an inorganic acid. In some embodiments, the inorganic acid is a food-acceptable acid or a food-acceptable salt thereof. Such food-acceptable acids are well-known in the art.

In some embodiments, the inorganic acid comprises a single acid. In some embodiments, the inorganic acid comprises a plurality of acids. In some embodiments, the inorganic acid comprises a mixture of acids. In some embodiments, the inorganic acid is selected from the group consisting of phosphorous acid, phosphoric acid, hydrochloric acid, sulfuric acid, nitric acid, including a salt, a derivative or any combination thereof. In some embodiments, the inorganic acid is characterized by a pKa value of less than 2.5, or less than 2.3.

In some embodiments, the acid component comprises a C1-C10 carboxylic acid, a salt thereof, or both. In some embodiments, the acid component comprises a C1-C10 carboxylic acid, a salt thereof, or a derivative thereof, such as an ester (e.g. a linear ester or a lactone, such as C2-C6 lactone). In some embodiments, the acid component comprises an ester of the C1-C10 carboxylic acid represented by Formula: R1-COOR, wherein R represents a linear or a cyclic C1-C10 alkyl, or a linear or a cyclic C1-C10 alkenyl, substituted or non-substituted, wherein substituted is as described herein. In some embodiments, the acid component comprises a salt (e.g. agriculturally or a food-acceptable salt) or a hydrate of the inorganic acid or of the C1-C10 carboxylic acid. In some embodiments, the acid component comprises a tautomer (e.g. a keto-enol tautomer) of the inorganic acid or of the C1-C10 carboxylic acid.

In some embodiments, the acid component comprises a food-acceptable C1-C10 carboxylic acid. In some embodiments, the acid component comprises a plurality of C1-C10 carboxylic acids. In some embodiments, the acid component comprises from 2 to 5, from 2 to 4, from 2 to 3, C1-C10 carboxylic acids. In some embodiments, the acid component comprises 3 C1-C10 carboxylic acids. In some embodiments, the acid component or the composition is substantially devoid of acetic acid.

In some embodiments, the C1-C10 carboxylic acid is an C1-C10 alkyl carboxylic acid represented by Formula: R1-COOH, wherein R1 represents a linear or a cyclic C1-C10 alkyl, or a linear or a cyclic C1-C10 alkenyl. In some embodiments, R1 represents a linear or a cyclic alkyl, or a linear or a cyclic alkenyl, wherein each of the alkyl and the alkenyl comprises between 1 and 2, between 1 and 3, between 2 and 5, between 2 and 4, between 3 and 5, between 4 and 6, between 2 and 6, between 5 and 10, between 5 and 7, between 7 and 10 carbon atoms, including any range or value therebetween. In some embodiments, R1 represents a linear or a cyclic alkyl, or a linear or a cyclic alkenyl, wherein each of the alkyl and the alkenyl comprises 1, 2, 3, 4, 5, 6, 7, 8, or 10 methylene units. In some embodiments, R1 represents a linear or a cyclic alkyl, or a linear or a cyclic alkenyl, wherein each of the alkyl and the alkenyl comprises between 1 and 6, between 1 and 2, between 1 and 3, between 2 and 5, between 2 and 4, between 3 and 5, between 4 and 6, between 2 and 6 methylene units, including any range or value therebetween. In some embodiments, R1 is hydrogen.

In some embodiments, the C1-C10 carboxylic acid comprises between 1 and 10, between 1 and 2, between 1 and 3, between 2 and 5, between 2 and 4, between 3 and 5, between 4 and 6, between 2 and 6, between 5 and 10, between 5 and 7, between 7 and 10 carbon atoms optionally substituted by 1, 2, 3, or 4 substituent(s), including any range or value therebetween.

In some embodiments, the alkyl is selected from a primary alkyl, a secondary alkyl, and a tertiary alkyl. In some embodiments, the alkyl is an alkenyl. In some embodiments, the alkyl is a substituted alkyl. In some embodiments, the alkyl is selected from a linear alkyl and a branched alkyl. In some embodiments, the substituted alkyl comprises one or more (e.g. 1, 2, 3, 4, or more) substituents. In some embodiments, the term “substituent” as used herein refers to one or more (e.g. 1, 2, 3, 4, or more) functional groups selected from a hydroxy group, a halo group, a carboxy group, an amide group, a carbonyl group, an anhydride, a carbonate ester, a carbamate, a cyano group, an amino group, a mercapto group, including any combination thereof.

In some embodiments, the C1-C10 carboxylic acid is a fruit acid. In some embodiments, the C1-C10 carboxylic acid is 2-hydroxy carboxylic acid. In some embodiments, the C1-C10 carboxylic acid is C1-C6 carboxylic acid. In some embodiments, the C1-C6 carboxylic acid is 2-hydroxy C1-C6 carboxylic acid. In some embodiments, the C1-C10 carboxylic acid is a beta-hydroxy carboxylic acid. In some embodiments, the C1-C10 carboxylic acid is selected from mono-, di-, or tri-carboxylic acids, including any combination thereof.

Non-limiting examples of C1-C6 2-hydroxy carboxylic acids contain but are not limited to: tartaric acid, citric acid, malic acid, mandelic acid, salicylic acid, ascorbic acid and lactic acid, or any combination thereof.

In some embodiments, the C1-C6 carboxylic acid comprises at least two carboxylic acids selected from the group consisting of: propionic acid, tartaric acid, glycolic acid, butanoic acid, pyruvic acid, citric acid, malic acid, mandelic acid, and lactic acid, or any combination thereof.

In some embodiments, the C1-C6 carboxylic acid is selected from the group consisting of propionic acid, lactic acid, citric acid, or a mixture thereof. In some embodiments, the acid component comprises propionic acid. In some embodiments, the acid component comprises propionic acid and an additional C1-C10 carboxylic acid. In some embodiments, the acid component comprises propionic acid, lactic acid, and citric acid. In some embodiments, the acid component is substantially devoid of an additional active ingredient. In some embodiments, the acid component consists essentially of propionic acid, lactic acid, and citric acid.

In some embodiments, the composition of the invention comprises: at least one fungicide; and at least one of propionic acid, lactic acid, and citric acid. In some embodiments, the composition comprises: the fungicide; propionic acid; and at least one of lactic acid and citric acid. In some embodiments, the composition comprises: the fungicide; propionic acid; and at least one of lactic acid and citric acid as active components. In some embodiments, the composition is substantially devoid of any additional active ingredient. In some embodiments, the composition consists essentially of the fungicide, propionic acid, lactic acid, and citric acid, wherein the fungicide is as described herein.

In some embodiments, the composition of the invention comprises a single fungicide or a plurality of fungicides (e.g. 2, 3, 4, 5). In some embodiments, the composition of the invention comprises a salt (e.g. agriculturally or a food-acceptable salt) or a hydrate of the fungicide. In some embodiments, the acid component comprises a tautomer (e.g. a keto-enol tautomer, an imine-enamine tautomer, amide-imidic acid tautomer) of the fungicide.

In some embodiments, the fungicide comprises a post-harvest fungicide. In some embodiments, the fungicide is or comprises an azole-based fungicide. In some embodiments, the azole-based fungicide comprises at least one azole ring. As used herein the term “azole” is related to a five-membered ring comprising at least two heteroatoms, such as imidazole, pyrazole, 1,2,3-triazole, 1,2,4-triazole, tetrazole, oxazole, thiazole, isothiazole etc. Diazine-based fungicides, azole-based fungicides and triazole-based fungicides are well-known in the art.

Non-limiting example of azole-base fungicides comprise but are not limited to: imazalil, fludioxonil, pyrimethanil, thiabendazole, amisulbrom, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, penconazole, pyraclostrobin, propiconazole, prothioconazole, quinconazole, simeconazole, tebuconazole, tetraconazole, triazbutil, triticonazole, uniconazole and uniconazole-P or any combination thereof. In some embodiments, the composition comprises a plurality of fungicides. In some embodiments, the fungicide substantially comprises the azole-based fungicide. In some embodiments, the composition is substantially devoid of any additional fungicide. In some embodiments, the fungicide is substantially devoid of any additional active ingredient.

Non-limiting example of azole-base fungicides comprise but are not limited to: bupirimate, diflumetorim, dimethirimol, ethirimol, fenarimol, nuarimol, triarimol, ferimzone, cyprodinil, imazalil, Fludioxonil, mepanipyrim, pyrimethanil or any combination thereof.

In some embodiments, the fungicide of the invention comprises one or more (e.g. 2, 3, or 4) of the fungicides disclosed herein. In some embodiments, the composition of the invention comprises a single fungicide.

In some embodiments, the fungicide comprises a basic functional group (such as an amino group, morpholine ring, or a heteroaromatic ring, such as diazine, triazole, pyrrole, tetrazole, etc.). In some embodiments, the fungicide is an imidazole-based fungicide (e.g. imazalil). In some embodiments, the fungicide consists essentially of azole-based fungicide. In some embodiments, the fungicide consists essentially of an imidazole-based fungicide (e.g. imazalil). In some embodiments, the fungicide consists essentially of diazine-based fungicide.

In some embodiments, a w/w ratio of the acid component to the fungicide within the composition is between 20:1 and 10:1, between 15:1 and 10:1, between 10:1 and 1:1, between 10:1 and 8:1, between 8:1 and 6:1, between 6:1 and 4:1, between 4:1 and 2:1, between 2:1 and 1:1, between 1:1 and 1:2, including any range or value therebetween, wherein the acid component and the fungicide are as described herein.

In some embodiments, a w/w ratio of the acid component (e.g. a total amount of at least one of propionic acid, lactic acid, and citric acid) to the fungicide (e.g. azole and/or triazole based fungicide) within the composition is between 20:1 and 10:1, between 15:1 and 10:1, between 10:1 and 1:1, between 10:1 and 8:1, between 8:1 and 6:1, between 6:1 and 4:1, between 4:1 and 2:1, between 2:1 and 1:1, between 1:1 and 1:2, including any range or value therebetween.

In some embodiments, a w/w ratio of the acid component to the fungicide, is between 8:1 and 6:1, between 6:1 and 4:1, between 4:1 and 2:1, between 2:1 and 1:1, between 1:1 and 1:2, including any range or value therebetween, wherein the acid component comprises propionic acid, lactic acid, and citric acid; and wherein the fungicide is an azole and/or triazole based fungicide.

In some embodiments, a w/w concentration of the acid component within the composition is at least 100 ppm, at least 150 ppm, at least 200 ppm, at least 250 ppm, at least 300 ppm, at least 350 ppm, at least 400 ppm, at least 450 ppm, at least 500 ppm, at least 550 ppm, at least 600 ppm, at least 650 ppm, at least 700 ppm, at least 800 ppm, at least 1000 ppm, at least 1500 ppm, at least 2000 ppm, at least 3000 ppm, including any range or value therebetween, wherein the acid component refers to a total amount of acids within the composition.

In some embodiments, a w/w concentration of propionic acid is from 5 to 10,000 ppm, from 10 to 30 ppm, from 30 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, a w/w concentration of propionic acid within the composition is at least 5, at least 10 ppm, at least 20 ppm, at least 30 ppm, at least 40 ppm, at least 50 ppm, at least 60 ppm, at least 70 ppm, at least 80 ppm, at least 100 ppm, at least 150 ppm, at least 200 ppm, at least 250 ppm, at least 300 ppm, at least 350 ppm, at least 400 ppm, at least 450 ppm, at least 500 ppm, at least 550 ppm, at least 600 ppm, at least 650 ppm, at least 700 ppm, at least 800 ppm, at least 1000 ppm, at least 1500 ppm, at least 2000 ppm, at least 3000 ppm, including any range or value therebetween. In some embodiments, a w/w concentration of propionic acid is at least 50 ppm.

In some embodiments, a w/w concentration of the acid component within the composition is from 10 to 10,000 ppm, from 10 to 30 ppm, from 30 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, a w/w concentration of the fungicide (e.g. azole-based fungicide, diazine-based fungicide, and/or triazole-based fungicide) within the composition is at least 20 ppm, at least 30 ppm, at least 40 ppm, at least 50 ppm, at least 60 ppm, at least 70 ppm, at least 80 ppm, at least 90 ppm, at least 100 ppm, at least 110 ppm, at least 120 ppm, at least 130 ppm, at least 140 ppm, at least 150 ppm, at least 170 ppm, at least 180 ppm, at least 190 ppm, at least 200 ppm, at least 220 ppm, at least 230 ppm, at least 250 ppm, at least 270 ppm, at least 300 ppm, at least 350 ppm, at least 400 ppm, at least 450 ppm, at least 500 ppm, at least 550 ppm, at least 600 ppm, at least 650 ppm, at least 700 ppm, at least 800 ppm, at least 1000 ppm, at least 1500 ppm, at least 2000 ppm, at least 3000 ppm, at least 5000 ppm, at least 7000 ppm, at least 10,000 ppm, at least 15,000 ppm, including any range or value therebetween.

In some embodiments, a w/w concentration of the fungicide within the composition is less than a recommended concentration of the fungicide. In some embodiments, the recommended dose is the recommended labeled dose of the fungicide for a single application. In some embodiments, the recommended dose is the labeled effective dose of the fungicide. In some embodiments, the recommended dose is the fungicidally effective amount, as described hereinabove.

In some embodiments, a w/w concentration of the fungicide within the composition is lowered by at least 10%, at least 20%, at least 50%, at least 100%, at least 150%, at least 200%, at least 500%, at least 1000%, including any range or value therebetween compared to a control having the same fungicidal activity. In some embodiments, the control is as described hereinabove. In some embodiments, the control is a fungicide solution being substantially devoid of the acid component of the composition.

In some embodiments, a concentration of the acid component, and of the fungicide, as described hereinabove, is related to the concentration within the end product such as an antimicrobial composition of the invention (e.g. ready-to-use composition directly applied to the substrate).

In some embodiments, the composition (e.g. the liquid composition) as described hereinabove, refers to a diluted composition (e.g. a ready-to-use composition directly applied to the substrate).

In some embodiments, the composition of the invention comprises a concentrate which is optionally diluted (e.g. prior to application), so as to obtain the above-mentioned concentration of any one of the active ingredients.

In some embodiments, a w/w concentration of the acid component within the concentrate is from 5 to 30%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

In some embodiments, a w/w concentration of the acid component within the concentrate is less than 10%, less than 15%, less than 20%, less than 25%, less than 30%, less than 35%, less than 40%, less than 45%, less than 50%, less than 55%, less than 60%, less than 70%, less than 80%, less than 90%, including any value therebetween.

In some embodiments, a w/w concentration of the fungicide within the composition (e.g. the concentrate) is from 0.1 to 30%, from 5 to 10%, from 10 to 15%, from 15 to 20%, from 20 to 25%, from 25 to 30%, from 0.1 to 0.5%, from 0.5 to 1%, from 1 to 2%, from 2 to 5%, from 5 to 7%, from 7 to 10%, from 10 to 20%, from 20 to 50%, from 50 to 80%, from 80 to 90%, including any range therebetween.

In some embodiments, a w/w concentration of propionic acid within the concentrate is from 5 to 30%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

In some embodiments, a w/w ratio of propionic acid to the additional acids (e.g. a total weight of citric acid and of lactic acid) within the composition is from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, a w/w ratio of citric acid to lactic acid within the composition is from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, the acid component comprises at least two C1-C10 carboxylic acids of the invention. In some embodiments, the acid component comprises at least three C1-C10 carboxylic acids of the invention.

In some embodiments, the acid component comprises propionic acid, citric acid and lactic acid, wherein the w/w ratio of propionic acid to citric acid is between 2:1 to 1:2 including any range therebetween. In some embodiments, the w/w ratio of propionic acid to lactic acid is between 2:1 to 1:2 including any range therebetween. w/w ratio of lactic acid to citric acid is between 2:1 to 1:2 including any range therebetween.

In some embodiments, the composition is characterized by a pH from 0 to 7. In some embodiments, the pH is from 0.01 to 0.05, from 0.05 to 0.1, from 0.1 to 0.5, from 0.5 to 1, from 1.0 to 1.5, from 1.5 to 2.0, from 2.0 to 2.5, from 2.5 to 3.5, 2.5 to 4.0, 2.7 to 3.5, 2.5 to 4.5, 3.0 to 4.0, 3.0 to 4.5, or from 3.5 to 4.5, or from 3.5 to 7 including any range therebetween.

In some embodiments, the concentration of the acid component is sufficient for reduction of pathogen load on a surface or within a container. In some embodiments, the acid component induces increased membrane permeability of the pathogenic cell. In some embodiments, the acid component increases membrane permeability of the pathogenic cell to the fungicide. In some embodiments, the pathogen is selected from fungi, bacteria or both. In some embodiments, the pathogen is characterized by a resistance to the fungicide.

In some embodiments, the composition is characterized by a reduced half minimum inhibitory concentration (MIC₅₀), compared to the control wherein the control is as described herein. In some embodiments, the fungicide within the composition has a reduced MIC₅₀ compared to the control. In some embodiments, reduced is by at least 10%, at least 20%, at least 50%, at least 100%, at least 150%, at least 200%, at least 500%, at least 1000%, including any range or value therebetween.

As defined herein, the term “half minimum inhibitory concentration (MIC₅₀)” is ½ of the lowest concentration of the active compound (e.g. a fungicide), which prevents visible growth of the pathogen (e.g. a plant pathogen as described herein). In some embodiments, pathogen growth is on or within the substrate. MIC₅₀ as defined herein, refers to a measure of the potency of a compound to inhibit pathogen growth. In some embodiments, a fungicide within the composition of the invention has MIC₅₀ at the tens of ppm level.

### Oxidizing Agent

In some embodiments, the composition of the invention further comprises an effective amount of an oxidizing agent. In some embodiments, the antimicrobial composition of the invention further comprises an antimicrobial effective amount of an oxidizing agent. In some embodiments, the oxidizing agent is capable of substantially reducing pathogen load on a substrate, as described herein. In some embodiments, the oxidizing agent is an anti-microbial agent. In some embodiments, the oxidizing agent characterized by an oxidation potential sufficient for conversion of a carboxylic acid (e.g. the C1-C10 carboxylic acid of the invention) into a corresponding peroxyacid. In some embodiments, the effective amount of an oxidizing agent is so as to induce or facilitate formation of an antimicrobial effective amount of a peroxyacid within the composition of the invention.

In some embodiments, the acid component comprises an inorganic acid. In some embodiments, the inorganic acid has sufficient acidity so as to induce formation of a synergistically effective amount of per-propionic acid within the composition (e.g. a liquid composition). Without being bound to any theory or mechanism, the inorganic acid of the invention may react with the oxidizing agent (such as H2O2, or PAA) so as to induce or catalyze formation of a synergistically effective amount per-carboxylic acid (such as perpropionic acid, perlactic acid, or percitric acid or a combination thereof).

In some embodiments, the composition of the invention comprises (i) an oxidizing agent, (ii) propionic acid, (iii) a fungicide, and optionally (iv) at least one of an inorganic acid and a C1-C10 carboxylic acid. In some embodiments, the composition comprises (i) an oxidizing agent, (ii) propionic acid, (iii) a fungicide, and optionally (iv) at least one of citric acid and lactic acid. In some embodiments, the composition is a liquid composition, further comprising a solvent, as described herein.

In some embodiments, the composition is an aqueous composition, comprising: 1) the oxidizing agent, 2) the acid component; 3) the fungicide, and 4) an aqueous solvent. In some embodiments, the composition is an aqueous composition, comprising: 1) the oxidizing agent, 2) the fungicide; 3) the acid component, 4) an aqueous solvent and 5) a surfactant. In some embodiments, the composition is an aqueous composition, comprising: 1) the oxidizing agent, 2) the acid component selected from (i) propionic acid, citric acid and lactic acid; and (ii) an inorganic acid (e.g. phosphorous acid) or a combination of (i) and (ii); 3) the fungicide, 4) an aqueous solvent and optionally 5) a surfactant and/or a stabilizer.

In some embodiments, the oxidizing agent is any of: a percarboxylic acid, hydrogen peroxide, ozone, urea hydrogen peroxide, sodium peroxide, calcium peroxide, silver or a silver salt, sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal, including any salt and/or any combination thereof.

In some embodiments, the oxidizing agent is any of a peroxide, a peroxide source or both. In some embodiments, the oxidizing agent is peroxycarboxylic acid. As used herein, the terms “peroxycarboxylic acid” and “percarboxylic acid” are used herein interchangeably.

In some embodiments, the oxidizing agent is selected from the group consisting of: hydrogen peroxide, urea hydrogen peroxide, silver, metal peroxide (such as sodium peroxide, calcium peroxide) and/or a derivative thereof, a percarbonate salt (such as sodium percarbonate, calcium percarbonate) and/or a derivative thereof, a periodate salt (such as sodium periodate) and/or a derivative thereof, a persulfate salt (such as sodium persulfate, ammonium persulfate) and/or a derivative thereof, a perborate salt (such as sodium perborate) and/or a derivative thereof, silver (II) oxide, perbenzoic acid and/or a derivative thereof (such as a chloro-perbenzoic acid, or a salt thereof), perchloric acid or a salt thereof, chlorine dioxide, benzoyl peroxide, a ketone peroxide, a peroxydicarbonate, a peroxyester, a dialkyl peroxide, a peroxyacetic acid (PAA), a hydroperoxide, a peroxyketal or any combination thereof. In some embodiments, the oxidizing agent comprises a silver salt and hydrogen peroxide.

In some embodiments, the derivative, as used herein is referred to a structural isomer and/or to a chemical derivative of any of the herein disclosed acids and/or oxidizing agents. In some embodiments, the derivative is a biologically active derivative having an anti-microbial or anti-pathogenic activity.

In some embodiments, the oxidizing agent is selected from the group consisting of: hydrogen peroxide, urea hydrogen peroxide, sodium peroxide, calcium peroxide, sodium percarbonate, sodium periodate, sodium persulfate, ammonium persulfate, sodium perborate, silver (II) oxide, chlorine dioxide, benzoyl peroxide, a ketone peroxide, a peroxydicarbonate, a peroxyester, a dialkyl peroxide, a hydroperoxide, a peroxyketal or any combination thereof.

In some embodiments, the percarboxylic acids is a food-acceptable percarboxylic acid. Such percarboxylic acids are well-known in the art. Non-limiting examples of percarboxylic acids include but are not limited to: peracetic acid (PAA), peroctanoic acid, perlactic acid, perpropionic acid, percitric acid, persalicylic acid, performic acid, including any mixture or a derivative thereof.

In some embodiments, the oxidizing agent is any of hydrogen peroxide, a source of hydrogen peroxide, peroxycarboxylic acid (such as PAA) or a combination thereof. In some embodiments, the oxidizing agent is or comprises hydrogen peroxide. In some embodiments, the oxidizing agent is or comprises PAA.

In some embodiments, the oxidizing agent substantially comprises any of hydrogen peroxide or a source thereof, and peroxycarboxylic acid (such as PAA), wherein substantially is as described herein. In some embodiments, the oxidizing agent is substantially devoid of an additional oxidizing agent. In some embodiments, the oxidizing agent is substantially devoid of an acid component. In some embodiments, the oxidizing agent is substantially devoid of an additional active ingredient. In some embodiments, the oxidizing agent consists essentially of hydrogen peroxide or a source thereof, or a peroxycarboxylic acid (such as PAA).

One skilled artisan will appreciate, that the exact concentration of the oxidizing agent within the composition may vary, depending on the strength of the oxidizing agent (as expressed by a standard oxidation potential thereof). For example, a per-acid (e.g. peracetic acid) has a greater oxidizing strength than hydrogen peroxide (HP), and is characterized by greater oxidation potential compared to HP. Accordingly, lower w/w concentration of the oxidizing agent is required, if peracetic acid is utilized as the oxidizing agent, as compared to a composition comprising HP as the oxidizing agent.

In some embodiments, the composition of the invention (e.g. the concentrate) comprises the oxidizing agent at a w/w concentration between 1 and 20%, between 0.5 and 10%, between 0.5 and 1%, between 1 and 3%, between 3 and 5%, between 5 and 10%, including any range or value therebetween.

In some embodiments, the composition of the invention (e.g. a diluted antimicrobial composition) comprises an antimicrobial effective amount of the oxidizing agent, wherein the antimicrobial effective amount is at least 5 ppm, at least 10 ppm, at least 30 ppm, at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, at least 500 ppm, at least 1000 ppm, at least 1500 ppm, including any range or value therebetween. In some embodiments, the w/w concentration of the oxidizing agent within the antimicrobial composition of the invention is between 10 and 1500 ppm, including any range between.

In some embodiments, a molar ratio of the oxidizing agent to the total acid content within the composition of the invention (e.g. the concentrate or the sanitizing composition) is from 5:1 to 1:5, from 5:1 to 5:2, from 5:2 to 5:3, from 5:3 to 4:1, from 4:1 to 3:1, from 3:1 to 1:1, from 1:1 to 1:2, from 1:2 to 1:3, from 1:3 to 1:4, from 1:4 to 1:5, including any range therebetween. In some embodiments, a total acid content is a sum of molar or weight contents of the acid component within the composition.

In some embodiments, a w/w ratio of the oxidizing agent to the propionic acid within the composition of the invention (e.g. the concentrate or the ready-to-use antimicrobial composition) is from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, the effective amount of the oxidizing agent and/or of the propionic acid within the composition of the invention comprises a w/w ratio between the oxidizing agent to the propionic acid being from 10:1 to 2:1, from 10:1 to 8:1, from 10:1 to 5:1, from 5:1 to 4:1, from 4:1 to 3:1, from 3:1 to 2:1, including any range therebetween.

### Liquid Composition

Without being bound to any particular theory, it is presumed that a mixture of the fungicide and the acid component, as described herein, is characterized by superior antimicrobial properties, comprising inter alia reduction of the pathogen load on or within the edible matter, and reduction of edible matter decay related to either pathogen load or to dehydration), over a composition solely comprising the same total content of the fungicide and being substantially devoid of at least one acid component as described herein.

In some embodiments, the composition is a liquid composition characterized by stability sufficient for applying thereof to a substrate. In some embodiments, the composition is inert to the substrate. In some embodiments, the composition is formulated for application on or within the substrate by any of: dipping, spraying, irrigating, foaming, etc. In some embodiments, the composition is formulated as a spray, a coating composition, a foam, a vaporized composition, an aerosol, etc.

In some embodiments, the composition is referred to as stable, when the concentration of any one of acids of the invention and/or the fungicide within the composition decreases by not more than 1%, not more than 5%, not more than 10% over 6 months at a temperature below 20° C. In some embodiments, the composition is referred to as stable, when the concentration of any one of acids of the invention and/or the fungicide within the composition decreases by not more than 1%, not more than 5%, not more than 10%, including any range between, over 6 months under appropriate storage conditions, as described herein.

In some embodiments, the composition is referred to as stable, when it is substantially devoid of phase separation for a time period disclosed herein. In some embodiments, the composition is referred to as stable, when it retains at least 80%, at least 90%, at least 95%, at least 97% of it antimicrobial activity, after a period of time disclosed herein.

In some embodiments, the composition further comprises a surfactant. In some embodiments, the surfactant is selected from the group consisting of a non-ionic surfactant, an anionic surfactant, a cationic surfactant and an amphoteric surfactant or any combination thereof.

Non-limiting examples of anionic surfactants include but are not limited to: (C₆-C₈)alkyl-sulfate and/or sulfonate (e.g., sodium or potassium lauryl sulfate, sodium or potassium dodecyl sulfate), fatty alcohol ether sulfate salt (e.g., (C₁₂-C₁₄)alkyl-O—(CH₂CH₂O)₂—SO₃—, ZOHARPON ETA 27), polyacrylate (e.g., sodium or potassium polyacrylates), or any combination thereof.

Non-limiting examples of non-ionic surfactants include but are not limited to: alkyl-polyglycoside (e.g., Triton CG 110, APG 810), polyethyleneglycol-(C₁₁-C₁₅)alkyl-ether (such as Imbentin AGS/35), alkoxylated fatty alcohol (such as Plurafac LF221), or any combination thereof.

In some embodiments, the surfactant (e.g. one or more surfactants) is selected from the group consisting of: Plurafac LF221, a polyacrylate, Triton CG 110, APG 810, ZOHARPON ETA 27, Imbentin AGS/35, Plurafac LF221, Disponil or any combination thereof.

In some embodiments, the composition further comprises an additive. In some embodiments, the additive is selected from the group consisting of: an organic additive (e.g., a scent or an odorant, a colorant, a pigment, an anti-freeze agent), an anti-foaming agent, an inorganic salt, an acid, a base, and a buffering agent or any combination thereof. In some embodiments, the additive comprises a hydrophobic compound as described herein (e.g. a wax).

In some embodiments, a w/w concentration of an additive within the composition (e.g. the concentrate) is from 0.1 to 20%, from 5 to 10%, from 10 to 15%, from 15 to 20%, from 0.1 to 5%, from 0.1 to 3%, from 0.1 to 2%, from 0.1 to 1%, including any range therebetween.

In some embodiments, a w/w concentration of the stabilizer within the composition (e.g. the concentrate) is from 0.05% to 10%, from 0.1 to 10%, from 0.1 to 5%, from 0.1 to 3%, from 0.1 to 2%, from 0.1 to 1%, including any range therebetween.

In some embodiments, a w/w concentration of the surfactant within the composition (e.g. the concentrate) is from 0.1 to 10%, from 0.1 to 5%, from 0.1 to 3%, from 0.1 to 2%, from 0.1 to 1%, including any range therebetween. In some embodiments, a w/w concentration of the surfactant is sufficient for stabilizing the composition of the invention. In some embodiments, stabilizing refers to substantial prevention of phase separation, and/or prevention of physical and/or chemical degradation of any one of the active ingredients of the composition.

In some embodiments, a w/w concentration of the hydrophobic compound (e.g. wax and/or edible coting) within the composition (e.g. the concentrate) is from 1 to 20%, from 1 to 5%, from 1 to 3%, from 1 to 2%, from 5 to 10%, from 15 to 20%, including any range therebetween.

In some embodiments, the composition of the invention is in form of spray (e.g. an aerosol spray), and/or a fogger that creates fine micro droplets from 0.1 to 10 micron further comprising a carrier gas.

Non-limiting examples of carrier gas include but are not limited to hydrogen, nitrogen, helium, argon or carbon dioxide, or any combination thereof.

The composition of the present invention can be in a variety of forms including aqueous solutions, suspensions, dispersion, emulsions, gels, foams, fogs, and sprays. In some embodiments, the composition of the invention is for use as a disinfectant fog and/or as a disinfectant mist.

The present compositions can be manufactured as dilute ready-to-use compositions, or as concentrates that can be diluted prior to use. The various compositions may also include fragrances, depending on the nature of the product.

In some embodiments, the composition of the present invention can be formulated into a disinfectant foam or foaming composition. The disinfectant foams or foaming compositions include the composition of the invention and foaming agents. Any foaming agent known in the art can be used depending on the desired application and characteristics of the resulting disinfectant foam.

In some embodiments, the composition of the present invention can be in the form of a disinfectant aerosol or a fog.

In some embodiments, the composition is stable under storage conditions, as described herein. In some embodiments, the composition or kit of the invention is stable upon storage at appropriate storage conditions for a time period ranging between 12h and 60d, or of at least 24 h, at least 12 h, at least 48 h, at least 72 h, at least 4 days (d), at least 5d, at least 7d, at least 10d, at least 15d, at least 18d, at least 20d, at least 30d, at least 45d, at least 60d, including any range or value therebetween.

In some embodiments, the composition is stable at a temperature of between 5 and 60° C., between 5 and 50° C., between 10 and 40° C., between 5 and 35° C. for at least 24 h, at least 12 h, at least 48 h, at least 72 h, at least 4 days (d), at least 5d, at least 7d, at least 10d, at least 15d, at least 18d, at least 20d, at least 30d, at least 45d, at least 60d, including any range or value therebetween. In some embodiments, the composition is stable at a temperature of less than 20° C. for at least 6 months, at least 12 months, including any range or value therebetween.

In some embodiments, the composition of the invention comprising the acid component, the fungicide, and the oxidizing agent is characterized by a reduced stability, compared to a composition devoid of the oxidizing agent. Accordingly, it is preferable to store the oxidizing agent in a separate container (e.g. in a form of a kit). The oxidizing agent can be mixed with the acid component and with the fungicide at least 2h, at least 12 h, at least 24h prior to application thereof to the substrate. The exact time period may be predefined by the specific oxidizing agent, and or by a predefined concentration of a peracid.

In some embodiments, the composition of the invention consists essentially of the active ingredients of the invention, wherein the active ingredient comprise the acid component of the invention, a fungicide disclosed herein, and optionally the oxidizing agent of the invention. In some embodiments, the composition of the invention at least 80%, at least 85%, at least 90%, at least 95%, at least 97%, at least 99%, at least 99.9% by dry weight (e.g. without the solvent) of the composition, consists essentially of the active ingredients, as described herein.

### Kits

In another aspect, the present invention provides a kit for combined preparations. In some embodiments, a “combined preparation” defines especially a “kit of parts” in the sense that the combination partners as described herein can be dosed independently or by use of different fixed combinations with distinguished amounts of the combination partners i.e., simultaneously, concurrently, separately or sequentially. In some embodiments, the parts of the kit of parts can then, e.g., be used simultaneously or chronologically staggered, that is at different time points and with equal or different time intervals for any part of the kit of parts. The ratio of the total amounts of the combination partners, in some embodiments, can be used in the combined preparation.

In another aspect of the invention, there is a kit comprising a first compartment comprising an inorganic acid, a C1-C10 carboxylic acid or both; and (ii) a second compartment comprising a fungicide. In some embodiments, the kit further comprises a third component, comprising the oxidizing agent of the invention.

In some embodiments, the kit comprises a first compartment comprising the acid component of the invention; and a second compartment comprising a fungicide of the invention. In some embodiments, the acid component, the inorganic acid, the C1-C10 carboxylic acid, and the fungicide are as described hereinabove. In some embodiments, the kit of the invention comprises (i) a first compartment comprising an inorganic acid, a C1-C10 carboxylic acid or both; and (ii) a second compartment comprising a coating composition. In some embodiments, the coating composition is a wax-based coating composition. In some embodiments, the coating composition is a hydrophobic coating as described herein.

A kit comprising (i) a first compartment comprising an inorganic acid, a C1-C10 carboxylic acid or both; and (ii) a second compartment comprising a fungicide, a coating composition or both. In some embodiments, the coating composition is a wax-based coating composition. In some embodiments, the coating composition is comprises the hydrophobic compound as described herein. In some embodiments, the coating composition is a hydrophobic coating as described herein.

In some embodiments, the kit comprises a first compartment comprising an inorganic acid, a C1-C10 carboxylic acid or both, and a second compartment comprising a fungicide. In some embodiments, the kit comprises a first compartment comprising an inorganic acid, propionic acid or both, and a second compartment comprising a fungicide and a third compartment comprising a C1-C10 carboxylic acid (e.g. citric acid, lactic acid or both). In some embodiments, the first compartment, the second compartment and the third compartment of the kit are liquids comprising an aqueous solvent, a polar organic solvent or both.

In some embodiments, the kit of the invention comprises a first compartment comprising propionic acid; a second compartment comprising lactic acid; and a third compartment comprising citric acid. In some embodiments, the kit of the invention comprises a first compartment comprising propionic acid; and a second compartment comprising lactic acid and citric acid.

In some embodiments, a w/w concentration of one or more acid component(s) within the first compartment is between 20 and 90%, between 20 and 30%, between 30 and 50%, between 50 and 55%, between 55 and 60%, between 60 and 65%, between 65 and 70%, between 70 and 90%, including any range or value therebetween.

In some embodiments, a combined w/w concentration of propionic acid, and at least one of lactic acid, citric acid a salt thereof, or both, within the first compartment is between 20 and 90%, between 20 and 30%, between 30 and 50%, between 50 and 55%, between 55 and 60%, between 60 and 65%, between 65 and 70%, between 70 and 90%, including any range or value therebetween.

In some embodiments, a w/w concentration of the fungicide within the second compartment is between 100 ppm and 99%, 100 ppm and 1000 ppm, between 1000 ppm and 0.1%, between 0.1 and 5%, between 5 and 20%, between 20 and 30%, between 30 and 50%, between 50 and 55%, between 55 and 60%, between 60 and 65%, between 65 and 70%, between 70 and 90%, including any range or value therebetween.

In some embodiments, a w/w concentration of the oxidizing agent within the third component is from 10 to 1000 ppm, from 1000 ppm to 0.1%, from 0.1 to 0.5%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

Without being bound to any particular theory or mechanism, upon mixing the first component and the third component of the kit, one or more peroxyacids are formed. As found by the inventors, a composition comprising a plurality of peroxyacids (such as the composition of the invention) is sufficiently less stable compared to a composition comprising a single peroxyacid. Therefore, in order to prolong its long-term stability, it is preferable to use a kit of the invention, wherein each of the first component and the third component are stored separately. Each of the first component, the second component, and the third component of the kit can be applied separately or as a mixture, such as in a form of the composition of the invention.

In some embodiments, the first and the second component, and the third component of the kit are mixed together so as to result in an exemplary antimicrobial composition of the invention. In some embodiments, the first, the second and third components of the kit are mixed together up to 48h before use of the composition. In some embodiments, the first, the second and third components of the kit are mixed together for at least 10s (e.g. if the second component comprises a per-acid). In some embodiments, the first, the second and third components of the kit are mixed in-situ within the supply system.

In some embodiments, any one of the first compartment, the second compartment, and the third compartment of the kit further comprise a solvent, wherein the solvent is as described hereinabove. In some embodiments, the first compartment, the third compartment and the second compartment, are aqueous compositions.

In some embodiments, any one of the first compartment, the third compartment and the second compartment is in a form of a dilute ready-to-use composition, or in a form of a concentrate that can be diluted prior to use. In some embodiments, the concentration of the acid component, and of the fungicide within any one of the compartments of the kit is as described hereinabove.

In some embodiments, the kit comprises instructions for mixing together any the compartments of the kit so as to obtain the composition of the invention. In some embodiments, the kit comprises instructions for dilution and optionally for mixing of the first compartment, the second compartment, and optionally the third compartment, so as to obtain a composition comprising a fungicidally effective amount of the fungicide. In some embodiments, the fungicidally effective amount of the fungicide is reduced by at least 10%, compared to a control, as described herein.

In some embodiments, the kit comprises instructions for dilution and optionally for mixing of the first compartment, the second compartment, so as to obtain a synergistically effective amount of the acid component and of the fungicide. In some embodiments, the kit comprises instructions for dilution and optionally for mixing of the first compartment, the second compartment, and optionally the third compartment, so as to obtain a synergistically effective amount of the acid component and of the fungicide and an antimicrobial effective amount of the oxidizing agent.

In some embodiments, the first, the second, and optionally the third compartments of the kit are mixed together up to 48h, up to 24h, up to 12h, up to 5h, up to 3h, up to 1h, before use of the resulting composition of the invention or the sanitizing composition. In some embodiments, the compartments of the kit are mixed together for at least 10 second before use. In some embodiments, mixing is as described hereinbelow.

In some embodiments, the first compartment, the second compartment and the third compartment of the kit are mixed together up to 30 days (d) before use of the resulting composition. In some embodiments, the first compartment, the second compartment and the third compartment of the kit are mixed simultaneously. In some embodiments, the first compartment, the second compartment and the third compartment of the kit are mixed subsequently. In some embodiments, the first compartment, and the second compartment and optionally the third compartment of the kit are applied simultaneously or subsequently.

In some embodiments, mixing comprises dosing the compartments in an amount sufficient for obtaining a predetermined molar ratio of the to the fungicide within the composition.

In some embodiments, the first compartment, the second compartment and the third compartment of the kit are diluted before mixing.

In some embodiments, dosing comprises dispensing a predetermined amount of the first compartment, a predetermined amount of the second compartment, a predetermined amount of the third compartment and subsequent mixing thereof. In some embodiments, dosing comprises dispensing a predetermined amount of the first compartment, a predetermined amount of the second compartment, so as to obtain a predetermined concentration of the acid component and/or of the fungicide within the composition, wherein the acid component and the fungicide are as described hereinabove.

In some embodiments, the acid component comprising propionic acid and at least one C1-C10 carboxylic acid is formulated within the first compartment, and the fungicide is formulated within the second compartment.

In some embodiments, at least one of the first composition and the second composition further comprises an agent selected from the group consisting of: a surfactant, an additive, and a stabilizer or any combination thereof, wherein the surfactant, the additive and the stabilizer are as described hereinabove.

In some embodiments, the first composition, the second composition, or both is stable for at least 12 months.

As used herein the term “stable” is referred to chemical stability of each of the components of the kit (such as the acids within the first composition and fungicide within the second composition of the kit.

As used herein the term “stable” is referred to the chemical stability and/or physical stability of the composition and/or of the kit of the invention. In some embodiments, a composition or kit is referred to as “stable” if it substantially retains its chemical composition upon storage under appropriate storage conditions. In some embodiments, a composition or kit is referred to as “stable” if it substantially retains its physical appearance (e.g. state of matter) and is substantially devoid of phase separation, precipitation, aggregation, agglomeration or turbidity under appropriate storage conditions.

In some embodiments, appropriate storage conditions comprise storage temperature of between 1 and 60° C., between 1 and 10° C., between 10 and 30° C., between 30 and 40° C., between 40 and 50° C., between 50 and 60° C. including any range between. In some embodiments, appropriate storage conditions comprise ambient atmosphere. In some embodiments, appropriate storage conditions comprise storage temperature as described herein, and storage time of at least 1 month (m), at least 2 m, at least 3 m, at least 4 m, at least 5 m, at least 6 m, at least 7 m, at least 8 m, at least 10 m, at least 12 m, including any range or value therebetween. In some embodiments, the term “stable” refers to a storage stability of the composition, wherein storage stability comprises stability under appropriate storage conditions, as described herein.

In some embodiments, the kit is stable for at least at least 1 month, at least 6 month, at least 1 year, at least 2 years, including any range or value therebetween. In some embodiments, the kit is stable under storage conditions, as described herein.

As exemplified hereinbelow, the composition or the kit of the invention exhibit synergistic antifungal effect. In some embodiments, the fungicide (e.g. imazalil) enhances fungicidal effect of a composition comprising the acid mixture, as described herein. In some embodiments, the composition comprising the acid component of the invention enhances fungicidal effect of the fungicide (e.g. imazalil), as exemplified by Example 1. Furthermore, a coating comprising an edible coting (e.g. wax-based coating) and a mixture of propionic, lactic and citric acids applied to an edible matter (e.g. fruits) resulted in a reduced pathogen loading and additionally improved the shelf-life and appearance of the treated fruits.

### Substrate

In another aspect of the invention, there is an article comprising a substrate in contact with the kit or the composition of the invention. In some embodiments, a substrate is in contact with the acid component of the invention and with the fungicide. In some embodiments, a substrate is in contact with a solid composition (e.g. a coating in a dry or solid form) comprising the acid component and the fungicide, wherein the acid component and the fungicide are as described hereinabove.

In some embodiments, the article of the invention comprises a substrate in contact with a solid composition comprising the acid component of the invention.

In some embodiments, the article of the invention comprises a substrate in contact with a solid composition consisting essentially of the acid component of the invention.

In some embodiments, the article of the invention comprises a substrate in contact with a solid composition consisting essentially of propionic acid, lactic acid and citric acid.

In some embodiments, the substrate (e.g. an edible matter) comprises significantly less fungicide residues compared to a control, wherein the control solution has the same concentration of the fungicide as the kit or the composition of the invention. In some embodiments, the fungicide residues on or within the substrate (e.g. an edible matter) is reduced by at least 30%, at least 50%, at least 100%, at least 150%, at least 200%, at least 500%, at least 1000%, including any range or value therebetween.

In some embodiments, the solid composition further comprises an agent selected from the group consisting of a surfactant, an additive, and a stabilizer or any combination thereof. In some embodiments, a w/w concentration of the agent within the composition (e.g. the concentrate) is from 0.1 to 10%, from 0.1 to 5%, from 0.1 to 3%, from 0.1 to 2%, from 0.1 to 1%, including any range therebetween.

In some embodiments, a substrate is a solid substrate, wherein the substrate is as described hereinbelow. In some embodiments, a solid substrate is a porous substrate, being characterized by a high surface area. In some embodiments, the porous substrate is in a crystalline state, in an amorphous state or a combination thereof. In some embodiments, the porous substrate comprises a gel.

In some embodiments, the solid composition is physically or non-covalently bound to the substrate. In some embodiments, the solid composition is bound to an outer surface of the substrate. In some embodiments, the substrate is as described hereinbelow.

In some embodiments, the article of the invention comprises a substrate coated with a solid composition, wherein the solid composition is as described herein.

In some embodiments, the article of the invention comprises a substrate in contact with a coating wherein the coating comprises a plurality of layers. In some embodiments, the coating is in a form of a layer. In some embodiments, the coating has a thickness of between 0.5 and 100 um, between 0.5 and 1 um, between 1 and 10 um, between 10 and 50 um, between 50 and 100 um, between 100 and 300 um, including any range therebetween. In some embodiments, the coating is a hydrophobic coating as described herein.

In some embodiments, the article of the invention comprises a substrate coated by a first layer comprising a hydrophobic coating; and by an additional layer comprising the solid composition, wherein the solid composition is as described herein.

In some embodiments, the article comprises the first layer in contact with the substrate and the additional layer on top of the first layer. In some embodiments, the article comprises the additional layer in contact with the substrate and the first layer on top of the additional layer.

In some embodiments, the hydrophobic coating comprises a hydrophobic compound. In some embodiments, the hydrophobic compound is a water insoluble compound select from the group comprising a lipid, a fatty acid including any salt and/or an ester thereof, a water insoluble polysaccharide (e.g. rice bran, or a gum), and a water insoluble protein or any combination thereof. In some embodiments, the hydrophobic coating comprises or consists essentially food-acceptable ingredients.

In some embodiments, the hydrophobic coating comprises a lipid selected from a fatty acid including any salt thereof, a monoglyceride, a di-glyceride, a tri-glyceride, or any combination thereof.

In some embodiments, the hydrophobic coating comprises a wax (e.g. an animal and/or a plant-based wax). Non-limiting example of waxes include but are not limited to: lanoline, beeswax, carnauba wax and candelilla wax, jojoba oil, and ouricury wax. Other waxes (e.g. food-acceptable waxes) are well known in the art.

Methods

In another aspect of the invention, there is a method for enhancing or prolonging activity of a fungicide, the method comprising (i) providing a substrate; and (ii) contacting the substrate with an effective amount of the composition or of the kit of the invention, thereby enhancing or prolonging activity of the fungicide. In some embodiments, the method is for enhancing or prolonging activity of a fungicide compared to a control. In some embodiments, the control is a fungicide solution having the same concentration of the fungicide as the composition or the kit of the invention.

In some embodiments, the method is for preventing or reducing pathogen load on or within the substrate, wherein reducing is by at least 10%, compared to the control. In some embodiments, preventing comprises prolonging the effect of the fungicide by at least 1d, at least 2d, at least 3d, at least 4d, at least 5d, at least 6d, at least 7d, at least 8d, at least 10d, compared to the control. In some embodiments, preventing comprises prolonging the effect of the fungicide by a time period being at least 10%, at least 50%, at least 100%, at least 500%, at least 1000% greater compared to the control.

In some embodiments, the method is for preventing or reducing pathogen load on or within the substrate, wherein reducing is by at least 10%, at least 50%, at least 100%, at least 500%, at least 1000%, compared to the control.

In some embodiments, the method for preventing or reducing pathogen load on or within the substrate comprises contacting the substrate with an effective amount of the composition or of the kit of the invention. In some embodiments, the term “effective amount” comprises a fungicidal effective amount (e.g. substantial reduction of a fungal load on or within the substrate). In some embodiments, the term “effective amount” comprises anti-microbial effective amount, wherein microbe comprises one or more plant pathogens, such as a plant virus, a plant fungus and/or mold, a plant bacterium, or any combination thereof.

In some embodiments, the method of the invention comprises contacting the substrate with an effective amount of the composition of the invention, wherein the composition comprises or consists essentially of the acid component, as described hereinabove.

In some embodiments, the method of the invention comprises contacting the substrate with an effective amount of the composition of the invention, wherein the composition comprises or consists essentially of propionic acid, citric acid and lactic acid, wherein a w/w concentration within the composition of any one of propionic acid, citric acid and lactic acid is at least 30 ppm, or at least 50 ppm.

In some embodiments, a w/w concentration of the fungicide within the composition or within the kit of the invention is the same compared to the control, wherein the control is not sufficient for preventing pathogen load on or within the substrate. In some embodiments, preventing comprises substantially preventing pathogen formation on or within the substrate for a time period of at least 8 days. In some embodiments, a concentration of the fungicide within the composition or within the kit is between 50 and 100 ppm, between 100 and 500 ppm, between 500 and 1000 ppm, between 1000 and 5000 ppm, between 5000 and 10000 ppm, including any range or value therebetween.

In some embodiments, the method comprises contacting a substrate with an effective amount of the antimicrobial composition or of the kit of the invention under conditions sufficient for reducing pathogen load on the substrate. In some embodiments, the method comprises contacting a substrate with an effective amount of the composition or of the kit of the invention under conditions sufficient for reducing fungal load on or within the substrate. In some embodiments, the substrate is contaminated with a plant pathogen (e.g. fungus, bacterium and/or virus). In some embodiments, the method is performed once or is performed repetitively (e.g. for 2, 3, 4, 5, or more times).

In some embodiments, the method is performed at one or more time points within the shelf life of an edible matter, such as pre-harvest, pre-seeding stage, growth, harvest, post-harvest, processing stage, storage and transport, up through consumption and/or destruction of the edible matter.

In some embodiments, the method comprises subsequently contacting a substrate with an effective amount of (i) the first compartment, (ii) the second compartment and optionally (iii) the third compartment, wherein the first compartment and the second compartment of the kit comprise an effective amount of acid component or of the fungicide respectively. In some embodiments, the method comprises step (i) of contacting the substrate with an effective amount of the first compartment and step (ii) of subsequently contacting the substrate with the second compartment comprising the fungicide. In some embodiments, the step (i) of the method comprises contacting the substrate simultaneously or subsequently with an effective amount of the first compartment and with an effective amount of the second compartment, wherein the effective amount is as described herein.

In some embodiments, the composition or the kit for use in the method of the invention, is referred to a ready-to-use composition or kit (i.e. diluted composition), as described hereinabove.

In some embodiments, the method is for preventing or controlling pathogen load on a substrate surface. In some embodiments, the method is for preventing or controlling pathogen load within the substrate.

In some embodiments, the method is for preventing or controlling pathogen related decay of an edible matter. As used herein, the terms “controlling” and “reducing” are used herein interchangeably.

In some embodiments, the method is for inducing or increasing susceptibility of the pathogen to the fungicide. In some embodiments, the method is for reducing or eradicating pathogen load on or with the substrate, wherein the pathogen is resistant to the fungicide. In some embodiments, the method is for reducing a resistance of the pathogen to the fungicide.

In some embodiments, controlling pathogen related decay comprises decay reduction by at least 10%, at least 20%, at least 30%, at least 50%, at least 100%, at least 150%, at least 200%, at least 300%, at least 400%, at least 500%, at least 600%, at least 700%, at least 800%, at least 900%, at least 1000%, compared to the substrate (e.g. an edible matter) treated by the control, wherein the control is as described herein.

In some embodiments, the method is for substantially preventing pathogen load and/or pathogen related decay of the substrate (e.g. edible matter). In some embodiments, substantially preventing is for a time period at least 1d, at least 2d, at least 3d, at least 4d, at least 5d, at least 6d, at least 7d, at least 8d, at least 9d, at least 10d, at least 11d, at least 12d, at least 13d, at least 15d, including any range or value therebetween.

In some embodiments, substantially preventing is by reducing pathogen related decay being less than 10%, less than 8%, less than 7%, less than 6%, less than 5%, less than 3%, including any range or value therebetween. In some embodiments, substantially preventing is less then less than 10%, less than 8%, less than 7%, less than 6%, less than 5%, less than 3%, less than 1%, less than 0.5% decay (e.g. pathogen related decay) of the edible matter, including any range or value therebetween.

In some embodiments, the method for substantially preventing pathogen load and/or pathogen related decay comprises contacting the substrate with the composition or with the kit of the invention, wherein the kit or the composition comprises less than 10000 ppm, less than 5000 ppm, less than 1000 ppm, less than 500 ppm less than 250 ppm, less than 200 ppm, less than 150 ppm, less than 100 ppm, less than 80 ppm, less than 70 ppm, less than 50 ppm, of the fungicide including any range or value therebetween.

In some embodiments, the method for reducing or substantially preventing pathogen load and/or pathogen related decay comprises contacting the substrate with the composition or with the kit of the invention, wherein a concentration (e.g. w/w or w/v) of the fungicide within the kit or the composition is lowered by at least 10%, at least 50%, at least 100%, at least 200%, at least 300%, at least 400%, at least 500%, at least 1000%, including any range or value therebetween, compared to the recommended dose of the fungicide.

In some embodiments, the method for substantially preventing pathogen load and/or pathogen related decay comprises contacting the substrate with the composition or with the kit of the invention, wherein the kit or the composition comprises less than 500 ppm, less than 250 ppm, less than 200 ppm, less than 150 ppm, less than 100 ppm, less than 80 ppm, less than 70 ppm, less than 50 ppm, of the fungicide (e.g. imazalil) including any range or value therebetween.

In some embodiments, the method is for prolonging the fungicidal effect of the fungicide. In some embodiments, prolonging is by at least 1d, at least 2d, at least 3d, at least 5d, at least 6d, at least 7d, at least 8d, at least 10d, including any range or value therebetween.

In some embodiments, the method comprises providing a substrate; and contacting the substrate with an effective amount of the composition or of the kit of the invention. In some embodiments, the method comprises providing the substrate; and contacting the substrate with an effective amount of the composition or of the kit comprising the acid component (e.g., inorganic acid, or a combination of lactic acid and citric acid), and the fungicide (e.g. imazalil). In some embodiments, contacting is under conditions sufficient for reducing pathogen load on or within the substrate. In some embodiments, the pathogen load is as described hereinbelow.

In some embodiments, the method of the invention comprises (i) providing a substrate; (ii) contacting the substrate with an effective amount of the composition or of the kit of the invention, and optionally drying the substrate, thereby obtaining a first coating layer in contact with the substrate. In some embodiments, the method further comprising contacting the substrate with a composition comprising a hydrophobic compound (e.g. a water insoluble compound select from the group comprising a lipid, a fatty acid including any salt and/or an ester thereof, a polysaccharide a protein or any combination thereof), thereby obtaining a second coating layer on top of the first layer. In some embodiments, the second coating layer comprises the hydrophobic coating of the invention.

In some embodiments, the method of the invention comprises (i) providing a substrate; (ii) contacting the substrate with an effective amount of a composition comprising a hydrophobic compound, thereby obtaining a hydrophobic coating layer in contact with the substrate; and (iii) contacting the substrate with an effective amount of the composition or of the kit of the invention thereby obtaining an additional coating layer on top of the hydrophobic coating layer. In some embodiments, each of steps (ii) and (iii) further comprises a step of drying the coating layer.

In some embodiments, contacting is under conditions sufficient for reducing or preventing pathogen load on the substrate. In some embodiments, contact time is for at least 0.1 min, at least 0.2 min, at least 0.3 min, at least 0.4 min, at least 0.5 min, at least 0.6 min, at least 0.7 min, at least 0.8 min, at least 0.9 min, at least 1 min, at least 2 min, at least 3 min, including any range or value therebetween.

In some embodiments, conditions sufficient for preventing or reducing pathogen load comprise a temperature of less than 0° C., above 0° C., above 1° C., above 2° C., above 5° C., above 10° C., above 15° C., above 20° C., above 25° C., above 30° C., including any value therebetween.

In some embodiments, contacting is at a temperature between 1 and 60° C., between 10 and 50° C., between 15 and 40° C., between 10 and 30° C., between 20 and 60° C., between 20 and 30° C., between 20 and 40° C., including any range or value therebetween.

In some embodiments, contacting is at a temperature between 10 and 90° C., between 10 and 50° C., between 50 and 90° C., between 50 and 60° C., between 60 and 70° C., between 70 and 80° C., between 80 and 90° C., including any range or value therebetween.

In some embodiments, the effective amount of the composition is such that at a contact time of one minute at a temperature of more than 10° C., more than 15° C., more than 20° C., more than 25° C., more than 30° C., more than 35° C., more than 40° C., the composition results in reduction of colony forming units (CFU) of a pathogen on or within the substrate by a factor of 10 to 1,000,000 as compared to a non-treated substrate, wherein the pathogen is as described hereinabove.

In some embodiments, the method comprises contacting a substrate with an effective amount of the composition for at least 30 seconds at a temperature of more than 10° C., more than 15° C., more than 20° C., more than 25° C., more than 30° C., more than 35° C., more than 40° C., more than 50° C., more than 60° C., thereby reducing pathogen load on the substrate by a factor of at least 10,000, of at least 100,000, of at least 1,000,000, including any value or arrange therebetween. In some embodiments, the method is for preventing pathogen growth on or within the substrate for at least 5 days (d), at least 10d, at least 15d, at least 20d, at least 30d, at least 40d, at least 50d, when stored at a temperature between 20 and 60° C. In some embodiments, the substrate is as described hereinbelow.

In some embodiments, the effective amount of the composition is such that at a contact time of at least 30 seconds at a temperature of more than 10° C., more than 15° C., more than 20° C., more than 25° C., more than 30° C., more than 35° C., more than 40° C., more than 50° C., more than 60° C., the composition results in reduction of CFU of a pathogen on or within the substrate by a factor of 10 to 1,000,000 as compared to a non-treated substrate, wherein the pathogen is as described herein.

In some embodiments, the effective amount of the composition is sufficient for substantially preventing pathogen formation on or within the substrate. In some embodiments, the effective amount of the composition is sufficient for substantially preventing pathogen formation for at least 3d, at least 4d, at least 5d, at least 6d, at least 7d, at least 8d, at least 9d, at least 10d, at least 11d, at least 12d, at least 13d, at least 15d, including any range or value therebetween.

In some embodiments, the effective amount comprises the fungicide at a w/w concentration within the composition or within the kit being between 50 and 70 ppm, between 70 and 90 ppm, between 90 and 100 ppm, between 100 and 150 ppm, between 150 and 200 ppm, between 200 and 250 ppm, between 250 and 300 ppm, between 300 and 350 ppm, between 350 and 400 ppm, between 400 and 500 ppm, between 500 and 1000 ppm, between 1000 and 10,000 ppm, including any range or value therebetween. In some embodiments, the effective amount comprises the fungicide in an amount less than a recommended dose of the fungicide. One skilled in the art will appreciate, that the recommended dose may vary depending on the fungicide and on the application method.

In some embodiments, the effective amount of the composition is sufficient for prolonging the effect of the fungicide by at least 5%, at least 10%, at least 20%, at least 30%, at least 40%, at least 50%, at least 60%, at least 70%, at least 80%, at least 90%, at least 100%, at least 150%, at least 200% including any range or value therebetween. In some embodiments, prolonging is compared to the control.

In some embodiments, the effective amount of the composition is sufficient for enhancing the effect of the fungicide by at least 5%, at least 10%, at least 20%, at least 30%, at least 40%, at least 50%, at least 60%, at least 70%, at least 80%, at least 90%, at least 100%, at least 150%, at least 200%, at least 300%, at least 400%, at least 500%, at least 600%, at least 700%, at least 800%, at least 900%, at least 1000%, including any range or value therebetween. In some embodiments, enhancing is compared to the control. In some embodiments, the effect is an antifungal effect.

In some embodiments, the method is for inhibiting or reducing pathogen load on or within a substrate, wherein inhibiting or reducing is compared to the control.

In some embodiments, the effective amount comprises the fungicide of the invention at a w/w concentration within the composition or within the kit of at most 100 ppm, at most 120 ppm, at most 150 ppm, at most 200 ppm, at most 250 ppm, at most 300 ppm, at most 400 ppm, at most 500 ppm, including any range or value therebetween.

In some embodiments, the effective amount comprises the fungicide of the invention at a w/w concentration within the composition (e.g. diluted composition) or within the kit of at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, including any range or value therebetween.

In some embodiments, the effective amount comprises the acid component of the invention at a w/w concentration within the composition (e.g. diluted composition) or within the kit of at least 100 ppm, at least 200 ppm, at least 300 ppm, at least 400 ppm, at least 150 ppm, at least 200 ppm, at least 250 ppm, at least 300 ppm, including any range or value therebetween.

In some embodiments, the effective amount comprises the acid component of the invention at a w/w concentration within the composition or within the kit being from 100 to 300 ppm including any range or value therebetween.

In some embodiments, the effective amount comprises propionic acid at a w/w concentration within the composition or within the kit being of at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, at least 500 ppm, including any range or value therebetween.

In some embodiments, the effective amount comprises propionic acid at a w/w concentration within the composition or within the kit being of at most 1000 ppm, at most 500 ppm, at most 200 ppm, at most 150 ppm, including any range or value therebetween.

In some embodiments, the effective amount comprises any of citric acid and lactic acid at a w/w concentration within the composition or within the kit being of at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, at least 500 ppm, including any range or value therebetween.

In some embodiments, the effective amount comprises any of citric acid and lactic acid at a w/w concentration within the composition or within the kit being of at most 1000 ppm, at most 500 ppm, at most 200 ppm, at most 150 ppm, including any range or value therebetween.

In some embodiments, the ratio (e.g., molar ratio) of citric acid to lactic acid within the composition is as described hereinabove.

In some embodiments, the method is for controlling pathogen load on the substrate surface. In some embodiments, the method is for reducing colony forming units (CFU) on the substrate and/or in the gas by a factor of 10 to 1,000,000, as compared to non-treated substrate surface.

As used herein, the terms “controlling” and “reducing” are used interchangeably and are related to reduction of colony forming unit (CFU)/cm² on the substrate surface, as compared to a non-treated substrate surface.

In some embodiments, the method is for reducing pathogenic activity on or within the substrate.

As used herein, the term “reducing pathogenic activity” refers to the ability to inhibit, prevent, reduce or retard bacterial growth, fungal growth, biofilm formation or eradication of living bacterial cells, or their spores, or fungal cells or viruses in a suspension, on or within the substrate, or in a moist environment, or any combination thereof. In some embodiments, inhibition or reduction or retardation of biofilm formation by a pathogen positively correlates with inhibition or reduction or retardation of growth of the pathogen and/or eradication of a portion or all of an existing population of pathogens.

In some embodiments, the method of the invention comprises reducing CFU/cm² on the substrate surface at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated substrate surface.

In some embodiments, the method of the invention comprises reducing CFU on or within the substrate at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated substrate surface.

Colonies start as single pathogen (CFU) which multiplies and forms a colony. Given enough CFUs close by, eventually, neighboring colonies will fuse. Increasing the magnification allows detection of micro-colonies before they fuse. In some embodiments, “colony” as used herein, refer to a colony observed by the naked eye. In some embodiments, “pathogen”, as used herein, refer to a microorganism such as bacteria and/or fungi.

In some embodiments, the method is for preventing or inhibiting or reducing pathogen load in or within the substrate. In some embodiments, the method is for substantially preventing pathogen infection of the substrate at a storage temperature of above 10° C., or above 20° C., or above 30° C., or above 40° C., during a time period of at least 3d, 5d, 10 days(d), at least 15 d, at least 12 d, at least 17 d, at least 20 d, at least 22 d, at least 25 d, at least 27 d, at least 30 d, at least 35 d, at least 40 d, including any range or value therebetween.

In some embodiments, the method is for substantially reducing or preventing pathogen infection of the substrate at a storage temperature of below 15° C. during a time period of at least 1 month (m), at least 1 month (m), at least 2 m, at least 3 m, at least 4 m, at least 5 m, at least 6 m, at least 7 m, at least 8 m, at least 10 m, at least 12 m, including any range or value therebetween.

In some embodiments, the method is for preventing or reducing post-harvest disease of the edible matter (e.g. a fruit, or a vegetable). In some embodiments, the method is for preventing or reducing pathogen related post-harvest decay of the edible matter. In some embodiments, the method is for preventing or reducing a pathogen related disease of the edible matter.

In another aspect, there is a method for reducing a dose of a fungicide applied to a substrate, the method comprises providing a substrate; and contacting the substrate with an effective dose of the composition or of the kit of the invention, wherein an amount the fungicide within the effective dose is less than a recommended dose for the fungicide. In some embodiments, the fungicide is applied for controlling pathogen load on or within the substrate.

In some embodiments, the method is for reducing a dose of a fungicide applied for controlling pathogen load on or within the substrate.

In some embodiments, the acid component is as described herein. In some embodiments, the substrate is as described herein.

In some embodiments, the method for reducing a dose of a fungicide comprises (i) providing a substrate, (ii) contacting the substrate with the first compartment of the kit, so as to obtain a pre-treated substrate and optionally (iii) applying the second compartment of the kit comprising an effective dose of the fungicide on the pre-treated substrate; wherein the first compartment of the kit comprises an effective amount of the acid component; and wherein contacting is performed simultaneously or sequentially. In some embodiments, the effective dose of the fungicide applied to the pre-treated substrate is reduced by at least 10%, compared to the recommended dose for the fungicide. In some embodiments, the dose of the fungicide sufficient for reducing pathogen load on or within the pre-treated substrate is diminished by at least 10%, compared to a dose of the fungicide sufficient for inducing the same reduction of the pathogen load on or within a non-treated substrate. In some embodiments, the effective dose of the fungicide is reduced by at least 10%, at least 30%, at least 50%, at least 70%, at least 100%, at least 150%, at least 200%, at least 300%, at least 400%, at least 500%, at least 600%, at least 700%, at least 800%, at least 900%, at least 1000%, including any range or value therebetween, compared to the recommended dose for the fungicide. In some embodiments, the recommended dose is sufficient for inducing the same reduction of the pathogen load when applied under the same conditions (e.g. temperature, substrate and contact time).

In some embodiments, the method of the invention is for reducing edible matter decay, wherein reducing is by at least 10%, at least 50%, at least 100%, at least 500%, at least 1000%, compared to a control. In some embodiments, the method is for enhancing storage stability and/or extending shelf life relative to untreated edible matter, wherein enhancing or extending is by at least 10%, at least 50%, at least 100%, at least 500%, at least 1000%, compared to a control. In some embodiments, the control is as described herein.

In some embodiments, edible matter decay is selected from the group consisting of loss from pathogen load, decomposing, sprouting, loss from a disease, rotting, dehydration, blackheart formation, loss from a higher organism or any combination thereof.

In some embodiments, the method is applied at one or more stages in a life-cycle of the edible matter (such as seeding, foliage, flowering, post-harvest, pre-harvest etc.).

In some embodiments, the substrate is selected for the group consisting of: an edible matter, soil, any growth medium, a propagation medium, a harvesting surface, a container, a storage surface, a transport surface, a packaging surface, a treatment surface, and a processing surface or any combination thereof.

In some embodiments, the method comprises contacting the composition with a substrate surface. Any surface can be treated by the composition of the invention (also referred to as “disinfectant”).

In some embodiments, the substrate is an interior surface of a container.

Examples of substrates that may be treated by the disinfectant include, but are not limited to: food processing equipment surfaces such as tanks, conveyors, floors, drains, equipment surfaces, walls, valves, belts, pipes, joints, crevasses, or any combination thereof.

The substrate can be metal, for example, aluminum, steel, stainless steel, chrome, titanium, iron, alloys thereof, and the like. The surfaces can also be plastic, for example, polyolefins (e.g., polyethylene, polypropylene, polystyrene, poly(meth)acrylate, acrylonitrile, butadiene, ABS, acrylonitrile butadiene, etc.), polyester (e.g., polyethylene terephthalate, etc.), and polyamide (e.g., nylon), combinations thereof, and the like. The surfaces may also be brick, tile, ceramic, porcelain, wood, vinyl, linoleum, or carpet, combinations thereof, and the like.

In some embodiments, the substrate is the exterior surface of the edible matter.

In some embodiments, the edible matter is selected from the group consisting of fruits, vegetables, grains, sprouts, nuts, seeds, meats, meat products, milk, milk products, fish, poultry, eggs, and mixtures thereof.

Non-limiting example of edible matter include but are not limited to: apple, avocado, citrus (e.g. clementine, orange, grapefruit, lemon), date, kiwi, lychee, mango, peach, pear, persimmon, pomegranate, pepper, asparagus, banana, broccoli, cabbage, carrot, cauliflower, celery, corn, kohlrabi, cucumber, eggplant, garlic, lettuce, onion, peanut, potato, strawberry, sweet pepper, sweet potato, tomato, watermelon, cannabis and grape or any combination thereof.

In some embodiments, the method comprises contacting the substrate with the composition of the invention, wherein the composition is in a liquid state, in a gaseous state, or in a form of an aerosol, including any combination thereof.

In some embodiments, the method comprises contacting the substrate with the composition of the invention, wherein contacting is selected from the group consisting of spraying, submerging, fogging, irrigating, dipping, and injecting or any combination thereof.

In some embodiments, contacting is by spraying the composition into the interior (e.g. ambient gas) of a container. In some embodiments, contacting is by fogging.

Fogging is a process by which a liquid composition (e.g. disinfectants) are aerosolized. The aerosol and/or fogging particles (micro droplets at a size of 0.1-10 micron) of the disinfectant are suspended within the ambient gas (e.g. air) for a period of time in order to disinfect both the air itself and surfaces, including inaccessible parts of a substrate.

Non-limiting example of pathogens include but are not limited to: cryophiles, nematodes, mites, ticks, fungi, algae, mold, bacteria, viruses, spores, yeast, and bacteriophages or any combination thereof.

In some embodiments, the pathogen is selected from the group consisting of bacteria, a fungus, a yeast, a virus, an algae, a mold, protozoa, an amoeba, and spore-propagating microorganisms or any combination thereof.

In some embodiments, bacteria are selected from the group consisting of gram-positive bacteria. In some embodiments, the gram-positive bacteria are selected from the group consisting of Staphylococcus, Streptococcus, Enterococcus, Bacillus, Corynebacterium, Nocardia, Clostridium, Actinobacteria and Listeria or any combination thereof.

In some embodiments, bacteria are selected from the group consisting of gram-negative bacteria. In some embodiments, the gram-negative bacteria are selected from the group consisting of Escherichia, Salmonella, Shigella, Enterobacteriaceae, Pseudomonas, Moraxella, Helicobacter, Stenotrophomonas, Bdellovibrio, acetic acid bacteria, Legionella, cyanobacteria, spirochetes, green sulfur bacteria, green non-sulfur bacteria, and respiratory symptoms Moraxella or any combination thereof.

In some embodiments, bacteria are selected from the group consisting of Escherichia coli, Staphylococcus aureus, Pseudomonas aeruginosa and Enterococcus hirae or any combination thereof.

In some embodiments, the fungus is selected from the group consisting of Penicillium, Magnaporthe, Ophiostoma, Cryphonectria, Fusarium, Ustilago, Alternaria, Cochliobolus, Aspergillus, Candida, Cryptococcus, Histoplasma, and Pneumocytis or any combination thereof.

the pathogen is a fungus selected from, but not limited to: mold, Alternaria spp. (e.g., Alternaria alternata, Alternaria solani); Aphanomyces spp. (e.g., Aphanomyces euteiches); Aspergillus spp. (e.g., Aspergillus niger, Aspergillus fumigatus); Atelia spp. (e.g., Atelia rolfsii); Aureobasidium spp. (e.g., Aureobasidium pullulans); Bipolaris spp. (e.g. Bipolaris zeicola, Bipolaris maydis); Botrytis spp. (e.g., Botrytis cinerea); Calonectria spp. (e.g., Calonectria kyotensis); Cephalosporium spp. (e.g., Cephalosporium maydis); Cercospora spp. (e.g., Cercospora medicaginis, Cercospora sojina, Colletotrichum coccodes, Colletotrichum fragariae, Colletotrichum graminicola); Coniella spp. (e.g., Coniella diplodiella); Colletotrichum spp.; Coprinopsis spp. (e.g., Coprinopsis psychromorbida); Corynespora spp. (e.g., Corynespora cassiicola; Curvularia spp. (e.g., Curvularia pallescens); Cylindrocladium spp. (e.g., Cylindrocladium crotalariae); Diplocarpon spp. (e.g., Diplocarpon earlianum); Diplodia spp. (e.g., Diplodia gossyina); Epicoccum spp. (e.g., Epicoccum nigrum); Erysiphe spp. (Erysiphe cichoracearum); Fusarium spp. (e.g., Fusarium graminearum, Fusarium oxysporum f sp. fragariae, Fusarium oxysporum f. sp. tuberosi, Fusarium proliferatum var. proliferatum, Fusarium solani, Fusarium verticillioides, Fusarium clumorum, Fusarium oxysporum f. sp. radicis-lycopersici, Fusarium euwallaceae); Ganoderma spp. (e.g., Ganoderma boninense); Geotrichum spp. (e.g., Geotrichum candidum); Glomerella spp. (e.g., Glomerella tucumanensis); Guignardia spp. (e.g., Guignardia bidwellii); Kabatiella spp. (e.g., Kabatiella zeae); Leptosphaerulina spp. (e.g., Leptosphaerulina briosiana); Leptotrochila spp. (e.g., Leptotrochila rnedicaginis); Macrophomina spp. (e.g., Macrophomina phaseolina); Magnaporthe spp. (e.g., Magnaporthe grisea, Magnaporthe oryzae); Microsphaera spp. (e.g., Microsphaera manshurica); Monilinia spp. (e.g., Monilinia fructicola); Mucor spp.; Mycosphaerella spp. (e.g., Mycosphaerella juiensis, Mycosphaerella fragariae); Nigrospora spp. (e.g., Nigrospora oryzae); Ophiostoma spp. (e.g., Ophiostoma ulmi); Penicillium spp. (e.g., Penicillium digitatum); Peronospora spp. (e.g., Peronospora manshurica); Phakopsora (e.g., Phakopsora pachyrhizi); Phoma spp. (e.g., Phoma foveata, Phoma medicaginis, Phoma tracheiphila); Phomopsis spp (e.g. Phomopsis longicolla); Phytophthora spp. (e.g., Phytophthora cinnamomi, Phytophthora erythroseptica, Phytophthora fragariae, Phytophthora infestans, Phytophthora medicaginis, Phytophthora megasperma, Phytophthora palmivora); Podosphaera (e.g., Podosphaera leucotricha); Pseudopeziza spp. (e.g., Pseudopeziza medicaginis); Puccinia spp. (e.g., Puccinia graminis subsp. tritici (UG99), Puccinia striiformis, Puccinia recodita, Puccinia sorghi); Pyricularia spp. (Pyricularia grisea, Pyricularia oryzae); Pythium spp. (e.g., Pythium ultimum, Pythium aphanidermatum); Rhizoctonia spp. (e.g., Rhizoctonia solani, Rhizoctonia zeae); Rosellinia spp., Sclerotinia spp. (e.g., Sclerotinia minor; Sclerotinia sclerotiorum, Sclerotinina trifoliorum); Sclerotium spp. (e.g., Sclerotium rolfsii); Septoria spp. (e.g., Septoria glycines, Septoria lycoperski); Setomelanomma spp. (e.g., Setomelanomma turcica); Sphaerotheca spp. (e.g., Sphaerotheca macularis); Spongospora spp. (e.g., Spongospora subterranean); Stemphylium spp., Synchytrium spp. (e.g., Synchytrium endobioticum), Verticillium spp. (e.g., Verticillium albo-atrum, Verticillium dahliae). In some embodiments, the fungus comprises Penicillium digitatum and/or Geotrichum candidum.

In some embodiments, the yeast is selected from the group consisting of Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae and Rhodotorula mucilaginosa or any combination thereof.

In some embodiments, the virus is selected from the group consisting of Adenoviruses, Herpesviruses, Poxviruses, Parvoviruses, Reoviruses, Picornaviruses, Togaviruses, Orthomyxoviruses, Rhabdoviruses, Retroviruses and Hepadnaviruses or any combination thereof.

In some embodiments, the method is for preventing biofilm formation on the substrate. In some embodiments, the method is for inhibiting biofilm formation. In some embodiments, the method is for reducing existing biofilms. In some embodiments, the method is for breaking-down existing biofilms.

As used herein the term “biofilm” refers to any three-dimensional, matrix-encased microbial community displaying multicellular characteristics. Accordingly, as used herein, the term biofilm includes surface-associated biofilms. Biofilms may comprise a single microbial species or may be mixed species complexes, and may include bacteria, or other microorganisms.

In some embodiments, the biofilm is essentially nullified or is reduced by at least 20%, at least 30%, at least 40%, at least 50%, at least 60%, at least 70%, at least 80%, at least 90%, including any value therebetween. Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

In some embodiments, the term “substantially” as used elsewhere herein, is at least 70%, at least 75%, at least 80%, at least 85%, at least 90%, at least 92%, at least 93%, at least 95%, at least 97%, at least 98%, at least 99%, at least 99.9% by weight, including any value therebetween.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### Example 1

### Reduced Decay of Citrus Fruits

The inventors successfully implemented a coating composition comprising propionic acid, lactic acid and citric acid at a concentration of 300 ppm (of total acid content) for coating of citrus fruits (such as lime). The treatments were performed by dipping (or by spraying) the fruits into a treatment solution at 15-30° C. for 30 seconds. Subsequently, the acid treated fruits were coated (e.g. by spraying) with a wax-based hydrophobic coating (e.g. carnauba wax coating). After treatment, the fruits were dried and kept at RT. The coated fruits were scored at day 28 post treatment.

The coated citrus fruits exhibited a prolonged shelf life and were characterized by reduced dehydration (about 40% reduction), by reduced spotting (about 30% reduction) and by reduced mechanical defects (about 60% reduction), compared to citrus fruits treated solely with the plant wax.

### Example 2

### Combined Treatment Reduces Decay of Citrus Fruits

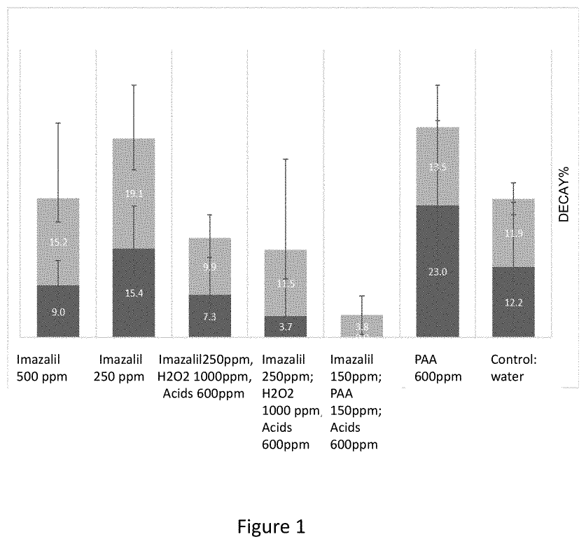

Experiment 2: 540 Clementine fruits was taken from a packinghouse and infected with 10⁵ Green Mold (Penecillium Digitatum). Nine treatments (each treatment was performed on 60 fruits) were performed 18-24h after inoculation. The treatments were performed by dipping the fruits into a treatment solution at 50° C. for 30 seconds. After treatment, the fruits were kept at RT. The number of decayed fruits was scored at day 7 and at day 13 post treatment. The results of this experiment are presented in FIG. 1.

Table 1 provided hereinbelow, lists the chemical composition of the treatment solutions.

TABLE 1
active agents within the treatment solutions of Experiment 2.
30 sec dipping treatment, no wash, 50° C.

control - water
PAA 150 ppm
IMZ 150 ppm + PAA 150 ppm + acids 600 ppm
IMZ 250 ppm + PAA 150 ppm + acids 600 ppm
IMZ 250 ppm + PAA 75 ppm + acids600 ppm
IMZ 250 ppm + H2O2(1000 ppm) + acids 2000 ppm
IMZ 250 ppm + H2O2(1000 ppm) + acids 600 ppm
IMZ 250
IMZ 500
“Acids” refer to a mixture of propionic acid, lactic acid and citric acid (1:1:1 w/w). Acids concentration (in ppm) is referred to the total concentration of abovementioned acids within the mixture.

As exemplified in FIG. 1, clementine fruits treated with a combination of hydrogen peroxide, acid mixture and 250 ppm imazalil significantly reduced fruit decay after 7 and 13 days, even compared to 500 ppm imazalil solution. Furthermore, clementine fruits treated with a combination of PAA (150 ppm), acid mixture (600 ppm) and 150 ppm imazalil almost completely prevented fruit decay even after 13 days post treatment.

### Example 3

### Combined Acid Treatment Versus Single Treatments

Fruits: Clementine; Inoculum: Penecillium Digitatum 10⁵; Inoculation: 24 hours prior to treatment.

Storage: Cartons of fruit from all the treatments were stored for several days at room temp to monitor fruit spoilage and treatment efficacy.

The results of this experiment are summarized below (Table 2), demonstrating that the combination of Imazalil, PAA as an oxidizer and of the acid blend (comprising lactic, propionic and citric acids) resulted in the lowest fruit decay, thus indicating a superior efficiency of the combined treatment over a single treatment with either PAA or with the fungicide.

TABLE 2
decay percentage after exemplary treatments

| | IMZ | PAA | ACIDS | % decay (waste) |
|---|---|---|---|---|
| | ppm | ppm | ppm | 12 days at room temp |
| Trial 1 | 250 | 0 | 0 | 55 |
| | 250 | 150 | 0 | 40 |
| | 250 | 150 | 700 | 31 |

| | IMZ | PAA | ACIDS | % decay (waste) |
|---|---|---|---|---|
| | ppm | ppm | ppm | 9 days at room temp |
| Trial 2 | 250 | 0 | 0 | 40 |
| | 250 | 150 | 0 | 60 |
| | 250 | 150 | 700 | 21 |
| | 500 | 0 | 0 | 19 |
| | IMZ | PAA | ACIDS | % decay (waste) |
| | ppm | ppm | ppm | 9 days at room temp |
| Trial 3 | | 150 | | 36 |
| | 150 | 150 | 700 | 4 |
| | 250 | 150 | 700 | 7 |
| | 250 | 70 | 700 | 4 |
| | 250 | 0 | 0 | 35 |
| | 500 | 0 | 0 | 24 |

In another experiment, clementine fruits were harvested and kept at room temperature for 2 days before treatment. Inoculum: natural (the fruit was not artificially inoculated). Storage: Cartons of fruit from all the treatments were stored for 3 weeks in cold storage and 1 week at room temp to monitor fruit spoilage and treatment efficacy.

The results of this experiment are summarized below, demonstrating that the combination of Imazalil, PAA as an oxidizer and of the acid blend (comprising lactic, propionic and citric acids) resulted in the lowest fruit decay, thus indicating a superior efficiency of the combined treatment over a single treatment. Especially, even at a low concentration of imazalil (350 ppm), the exemplary composition of the invention comprising 700 ppm of total acid content (lactic, citric, and propionic acids) and 50 ppm of the oxidizing agent (PAA) resulted in an improved antimicrobial activity, compared to a single administration of imazalil (350 ppm).

TABLE 3
decay percentage after exemplary treatments

| | IMZ | PAA | ACIDS | |
|---|---|---|---|---|
| | ppm | ppm | ppm | % decay |
| Trial 4 | 350 | 50 | 700 | 12.2 |
| | 350 | | | 16.8 |
| | 350 | 50 | 700 | 11.5 |
| | 350 | | | 9.4 |

Furthermore, the inventors successfully demonstrated a synergistic effect by administering the acid blend together with a pyrrole-based fungicide (fludioxonil) to mango fruits. Mango fruits were stored for three weeks in the cold and one week at room temperature and evaluated for decay incidence. At the tested concentrations (75 ppm of fludioxonil and 0.75% w/w of the acid blend) a complete arrest of fruit decay was achieved. A similar effect could by achieved only by implementing of 150 ppm fludioxonil as a single treatment. Accordingly, it is postulated, that any azole-based fungicide (e.g. comprising a heteroaryl) will exhibit a synergistic effect within the antimicrobial composition of the invention.

### Example 4

### Pre-Harvest Treatment of Mandarin Fruits

Each treatment was applied to three mandarin (cv. Tango) trees pre-harvest (by spraying). The pre-harvested fruits have been inoculated from waist to chest height with spore suspensions (10⁵ conidia/mL) of Penicillium digitatum and/or Geotrichum candidum using backpack sprayer. Inoculum suspension was applied in the morning and allowed to dry.

Treated pre-harvested fruits were sprayed with a composition comprising the oxidizer (100-3000 ppm of PAA or H2O2), the acid blend as described in the Example 3 (500-5000 ppm), and azoxystrobin fungicide. The fruits have been scored 1-week post-harvest (stored at about 20° C.).

When the above-mentioned composition has been applied at 14 ounce/acre of the fungicide (lowest recommended dose), the inventors observed a significant antimicrobial effect, and successfully reduced both Penicillium and Geotrichum (Sour Rot)-related decay of the tested fruits.

Superior results were obtained with the combination of oxidizer, acid blend and fungicide, as compared to using only fungicide at a higher concentration. Same trend was obtained for fruits tested with natural incidences of Geotrichum and Penicillium.

Without being bound to any particular theory, the hereindisclosed compositions and/or kits may be advantageous such as for reducing the amount of fungicide applied to an edible matter, for the preservation of the edible matter (e.g. fruits and/or vegetables), and/or for reducing decay of an edible matter (e.g. due to the improved curative control).

Strong effect in residue loading when used in dip tank—fungicide residue decreases however residue persistence over a longer period (less degrades). The persistence of fungicides on the surface of the fruit is what allows the excellent sporulation inhibition properties. Overall, a minimum limit of residue recommended may be reduced as effective compound concentration maintain longer.

Since most fungicides are weak bases, it is most soluble in an aqueous low pH solution, so as to retain the fungicide molecule in an ionized form. (e.g. with a charged or protonated nitrogen group).

It is postulated, that the undissociated, uncharged organic acids penetrate across the cell membrane of the microorganism (e.g. fungus), thus enhancing cellular penetration of fungicides.

Fungicide penetrated deeper into the exocarp (migrate deeper into the fruit) and more readily permeate fungal membranes and persists longer.

Furthermore, the herein disclosed compositions/kits allow compatibility of common sanitizer (e.g. peracetic acid) with fungicides. By applying (e.g. via dipping) the composition of the invention to the edible matter it is possible to maintain the concentration of the fungicide within the dipping bath without any need for monitoring or adjusting the fungicide concertation during the treatment process. Therefore, the concentration of the fungicide within the dipping bath does not need to be measured and managed constantly. Accordingly, less deviations, due to variations in fruit maturity, climate and cultivar, are often observed during the treatment process.

Furthermore it is postulated without being limited to any particular mechanism, that the coating composition of the invention reduces a pH on the surface of the treated fruit. This, in turn, interferes with cellular permeability of the pathogenic membrane and might prevent further synthesis of membranes. Accordingly, the loading and/or propagation of pathogens on or within the fruit is substantially reduced.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A antimicrobial composition comprising an effective amount of an acid component, and a fungicidally effective amount of a fungicide; wherein said acid component comprises (i) an inorganic acid, a salt thereof or both; (ii) a C1-C10 carboxylic acid a salt thereof or both, or a combination of (i) and (ii); and wherein the effective amount of the acid component is so that the fungicidally effective amount of the fungicide is reduced by at least 10%, compared to a similar antimicrobial composition without the acid component.

2. The antimicrobial composition of claim 1, wherein the effective amount of the acid component comprises a weight per weight (w/w) ratio of said acid component to said fungicide within the antimicrobial composition of between 15:1 and 1:2.

3. The antimicrobial composition of claim 1, wherein the fungicidally effective amount is at least 30 ppm.

4. The antimicrobial composition of claim 1, wherein the effective amount of the acid component within said antimicrobial composition is at least 50 ppm; and wherein said C1-C10 carboxylic acid is selected from the group consisting of propionic acid, tartaric acid, glycolic acid, butanoic acid, pyruvic acid, citric acid, malic acid, mandelic acid, and lactic acid, including any salt and any combination thereof.

5. (canceled)

6. The antimicrobial composition of claim 1, wherein said acid component comprises propionic acid and at least one additional C1-C10 carboxylic acid; and wherein said fungicide comprises an azole-based fungicide, a diazine-based fungicide or both.

7. The antimicrobial composition of claim 1, wherein said acid component comprises propionic acid, lactic acid and citric acid wherein a w/w ratio between (i) the propionic acid and (ii) any one of the lactic acid and the citric acid is between 2:1 and 1:2.

8. (canceled)

9. The antimicrobial composition of claim 1, wherein said inorganic acid is selected from the group consisting of phosphorous acid, phosphoric acid, hydrochloric acid, sulfuric acid, nitric acid, including any salt and any combination thereof; optionally wherein said acid component comprises phosphorous acid.

10. (canceled)

11. The antimicrobial composition of claim 1, wherein the composition further comprises an acceptable carrier, optionally wherein the acceptable carrier is a food-acceptable carrier.

12. (canceled)

13. The antimicrobial composition of claim 1, further comprising an antimicrobial effective amount of an oxidizing agent wherein the antimicrobial effective amount of the oxidizing agent is at least 10 ppm and wherein a pH of said composition is between 0 and 7.

14. (canceled)

15. (canceled)

16. The antimicrobial composition of claim 1, wherein said composition further comprises an agent selected from the group consisting of: a carrier gas, a solvent, a surfactant, an additive, and a stabilizer or any combination thereof, and wherein a concentration of said agent within said composition is in a range from 0.01 to 20%; optionally wherein the agent comprises the surfactant at a concentration sufficient for stabilizing said antimicrobial composition.

17. (canceled)

18. The antimicrobial composition of claim 13, wherein the oxidizing agent is selected from the group consisting of: a percarboxylic acid, hydrogen peroxide, urea hydrogen peroxide, sodium peroxide, calcium peroxide, silver or a silver salt, sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal, including any salt and any combination thereof.

19. The antimicrobial composition of claim 1, wherein said antimicrobial composition is stable for at least 24h.

20. A kit comprising a first compartment comprising (i) an inorganic acid, a salt thereof, or both; (ii) a C1-C10 carboxylic acid, a salt thereof, or both; or both (i) and (ii); and a second compartment comprising a fungicide wherein said inorganic acid is selected from the group consisting of phosphorous acid, phosphoric acid, hydrochloric acid, sulfuric acid, nitric acid, including any salt and any combination thereof.

21. (canceled)

22. The kit of claim 20, wherein said C1-C10 carboxylic acid is selected from the group consisting of propionic acid, tartaric acid, glycolic acid, butanoic acid, pyruvic acid, citric acid, malic acid, mandelic acid, and lactic acid, including any salt and any combination thereof and wherein said fungicide comprises an azole-based fungicide, a diazine based fungicide or both; and wherein said kit further comprises an oxidizing agent.

23. (canceled)

24. (canceled)

25. The kit of claim 20, wherein the oxidizing agent is selected from the group consisting of: a percarboxylic acid, hydrogen peroxide, urea hydrogen peroxide, sodium peroxide, calcium peroxide, silver or a silver salt, sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal, including any salt and any combination thereof; wherein any one of said first compartment, and said second compartment, further comprises an acceptable carrier; and optionally comprises an agent selected from the group consisting of: a surfactant, an additive, a solvent, and a stabilizer or any combination thereof; and wherein any one of said first compartment, said second compartment, and said third compartment is stable for at least 6 months; optionally wherein the acceptable carrier is a food-acceptable carrier, and wherein the kit further comprising instructions for dilution and optionally for mixing of said first compartment and said second compartment, so as to obtain a composition comprising a fungicidally effective amount of said fungicide.

26. (canceled)

27. (canceled)

28. (canceled)

29. (canceled)

30. A method comprising contacting a substrate with an effective amount of (i) the antimicrobial composition of claim 1, or (ii) the kit of claim 20; thereby enhancing or prolonging activity of said fungicide, or controlling pathogen related decay of an edible matter; wherein said effective amount comprises a concentration of said fungicide within said composition or within said kit being between 50 and 10,000 ppm; optionally wherein said pathogen is a plant pathogen selected from the group consisting of a virus, a bacterium, a yeast and a fungus or any combination thereof.

31. (canceled)

32. (canceled)

33. (canceled)

34. (canceled)

35. (canceled)

36. (canceled)

37. (canceled)

38. (canceled)

39. An article comprising a substrate in contact with the antimicrobial composition of claim 1, or with the kit of claim 20; wherein said substrate is selected for the group consisting of: an edible matter, a growth medium, a propagation medium, a harvesting surface, a container, a storage surface, a transport surface, a packaging surface, a treatment surface, and a processing surface or any combination thereof.

40. (canceled)

41. The article of claim 39, wherein said substrate comprises the edible matter further comprising a hydrophobic coating, a fungicide residuals or both; wherein said hydrophobic coating comprises a water insoluble compound selected from the group comprising a lipid, a fatty acid, a water insoluble polysaccharide, and a water insoluble protein or any combination thereof; wherein said fungicide comprises an azole-based fungicide, a diazine-based fungicide or both; and wherein the edible matter is characterized by any of (i) reduced pathogen load, (ii) prolonged storage shelf-life or both (i) and (ii); compared to an edible matter treated with a composition or with a kit comprising a similar amount of the fungicide without the acid component.

42. (canceled)

43. (canceled)

44. (canceled)
